(19) United States
(12) Patent Application Publication
(10) Pub. No.: US 2014/0358340 A1
(43) Pub. Date: Dec. 4, 2014

(54) Hybrid electric vehicle

(71) Applicant: Vladimir Radev, Mays Landing, NJ (US)

(72) Inventor: Vladimir Radev, Mays Landing, NJ (US)

(21) Appl. No.: 13/986,705

(22) Filed: May 28, 2013

(51) Int. Cl. B60W 20/00; B60W 10/06; B60K 6/442; B60W 10/26; B60W 10/184; B60W 10/196; B60W 10/02; B60W 10/08

(52) U.S. Cl. CPC B60W 20/20; B60W 10/02; B60W 10/06; B60W 10/08; B60W 10/26; B60W 10/184; B60W 10/196; B60K 6/442; B60W 2600/00; Y10S 903/93
USPC 701/22; 180/65.23; 180/65.265

(57) ABSTRACT

In a first forward drive mode, at speeds of the vehicle lower than a predetermined speed, an electric traction motor (17) drives the wheels (12, 13) of the vehicle, while an internal-combustion engine (27) drives an electric generator (34) or rests. The generator charges an electric battery (38), or powers the traction motor, or both. In a second forward drive mode, at speeds of the vehicle higher than the predetermined speed, the engine drives the electric generator and the wheels of the vehicle, while the traction motor is not energized. In a third forward drive mode, at speeds of the vehicle higher than the predetermined speed, the traction motor, powered by the electric battery, together with the engine drive the wheels of the vehicle. In a reverse drive mode the traction motor alone drives the wheels of the vehicle. A clutch (32) selectively interrupts the power transmission between the engine and the wheels of the vehicle. The traction motor selectively operates as an electric braking generator, during speed retardation and braking of the vehicle, and charges the electric battery. A central electronic controller (46) controls and coordinates the operation of the clutch, traction motor, and engine for achieving high fuel efficiency at both city and highway operational conditions.

### FIELD OF THE INVENTION

This invention relates generally to self-propelled vehicles, and more particularly to hybrid electric vehicles.

### BACKGROUND OF THE INVENTION

The term “hybrid electric vehicle” is usually used in the art to indicate a vehicle with a drive system including an internal-combustion engine and at least one electric traction motor. The terms “electric traction motor” is used to distinguish an electric motor utilized for vehicle propulsion from all other electric motors that may be employed in a vehicle.

The sources of electric energy for the electric traction motor(s) are usually an electric generator driven by the internal-combustion engine, and an electric traction battery charged by the electric generator. In some hybrid electric vehicles, the electric traction battery is also arranged to be charged by an external source of electric energy when the vehicle is parked. The term “electric traction battery” is used to distinguish the large high-voltage electric battery used for powering the electric traction motor(s) from the standard low-voltage electric battery, which powers the other electric system of the vehicle. Hereinafter, for abbreviation, the shorter terms “engine”, “traction motor”, “generator” and “electric battery” are frequently used instead of the terms “internal-combustion engine”, “electric traction motor”, “electric generator” and “electric traction battery” respectively.

### The Internal-Combustion Engine

It is well known that an ideal source of mechanical energy for propulsion of an automotive vehicle would be a machine providing a constant power output throughout its entire speed range. Such a characteristic of the power output corresponds to a hyperbolic characteristic of the torque output. A source of mechanical energy with such characteristics would provide large torque at relatively low vehicle speeds, i.e. exactly when large tractive force, and therefore large torque, is demanded for starting the motion, accelerating, and uphill driving. In this regard, of all possible power sources for automotive vehicles, the internal-combustion engine has the most unfavorable power-torque characteristics. The internal-combustion engine cannot run and produce useful power below a certain minimum (idle) engine speed. It has to be started by another source of mechanical energy—usually by an electric motor. The power and torque output at a low speeds of an internal-combustion engine are relatively low. The optimum combustion quality is reached at some medium engine speed where, consequently, the maximum engine torque is developed. The engine speed at maximum torque coincides approximately to the engine maximum fuel-efficiency speed. Generally, the fuel efficiency of the internal-combustion engines is relatively low when the engine operates near the low end or near the high end of its entire rotational speed range. Somewhere in between, depending on the specific type and design of the engine, is the engine high fuel-efficiency speed range.

Because of these unfavorable power-torque characteristics, the internal-combustion engine is used in the conventional automotive drive systems in conjunction with a frictional clutch and a manual gear-shift transmission, or with a hydrodynamic coupling (or torque converter) and an automatic gear-shift transmission or a continuously-variable-speed transmission. The transmission enables the engine to operate more or less close to the engine optimum fuel-efficiency speed at different vehicle speeds, and particularly during the most frequently used part of the entire vehicle speed range. Other disadvantages of the internal-combustion engine are the significant drop of the engine efficiency under conditions of part-load operation, and the production of environmentally harmful exhaust emissions. Paradoxically, in spite of all its disadvantages, the internal-combustion engine is the source of mechanical power in the vast majority of the automobiles worldwide, due principally to its excellent operational readiness, high power-to-weight ratio, wide availability of fuel, and quick refueling capability.

### The Electric Traction Motor

In contrast to the power-torque characteristics of the internal-combustion engine, the power-torque characteristics of the electric traction motors are the most favorable for propelling automotive vehicles. Contemporary electric traction motors are capable of providing the maximum motor torque from standstill up to a certain speed of the motor, and the maximum motor power from that point up to the maximum speed of the motor. Furthermore, most of the electric traction motors can be briefly overloaded up to 2 or 3 times of their continuous-power rating. The mechanical drive train from the rotor of the electric traction motor to the wheels of a drive axle is usually simple and efficient. The control of the continuously variable tractive force of the vehicle is also relatively simple. Nevertheless, in spite of its many advantages, including its environmentally clean operation, the electric vehicle drive still has limited applications, mainly because of the relatively low energy-storage capacity of the contemporary electric batteries in ratio to their weight and size, and the long battery charging time.

### The Hybrid Electric Vehicle

The fundamental goal in the development of hybrid electric vehicles is to combine the two sources of mechanical energy—the internal combustion engine and the electric traction motor—so that the advantages of each of them are utilized under varying operating conditions in such a manner that the improvement in fuel efficiency, improvement of performance characteristics, reduction of exhaust emissions of harmful substances, and other advantages justify the higher cost of the hybrid vehicles. The main difference between various hybrid electric vehicles is the series or parallel arrangement of the power sources of mechanical energy within the power train of the vehicle.

### The Series Hybrid Electric Vehicle

In the series hybrid electric vehicles, the internal-combustion engine, operating at a substantially constant speed in the vicinity of its optimum speed in terms of fuel efficiency and emissions, drives the electric generator, which in its turn charges the electric battery and supplies the electric traction motor with electric energy. In this arrangement, only the electric traction motor drives the wheels of the vehicle via an appropriate drive train. The direction of rotation of the rotor of the traction motor is reversible for selectively driving the vehicle in reverse.

As far as the driving of the vehicle is concerned, the series hybrid electric vehicle operates as an electric vehicle, because the internal-combustion engine is not mechanically connected with the drive train of the vehicle. The operation of the traction motor is controlled by an electrically controllable traction motor controller. The operator of the vehicle controls the continuously variable tractive force of the vehicle by varying the depression of the accelerator pedal, which is appropriately connected with the traction motor controller.

The internal-combustion engines of the series hybrid electric vehicles are usually narrow-speed-range machines with higher fuel efficiency than that of the comparable engines with wider speed range used in the conventional vehicles. The efficient narrow-speed-range internal-combustion engine, operating at substantially constant speed within the engine optimum speed range, in terms of fuel-efficiency and exhaust emissions, is the major advantages of the series arrangement. The simplicity of the mechanical drive, and the simple and direct control of the continuously-variable tractive force of the vehicle are the other major advantage of the series arrangement.

On the other hand, because the mechanical energy generated by the engine must be converted several times during the entire operational cycle of the vehicle, the total efficiency of the power train may be lower than that of a conventional vehicle. Another major disadvantage of the series hybrid vehicles is that the combined power of the internal-combustion engine and the electric traction motor cannot be used during high power demand. In the series arrangement, the electric traction motor, and consequently the entire electric power train, must be large enough to be able to drive the vehicle and meet the performance requirements within the complete speed range of the vehicle.

A series arrangement is justifiable in relatively low-speed vehicles with frequent stop-and-go duty cycles, such as city buses, mail and parcels delivery vehicles for city operations, and other similar frequent stop-and-go vehicles operating in densely populated areas. In such vehicles the electric traction motor and, when the electric traction battery is sufficiently charged, the internal-combustion engine do not operate during the time of the frequent stops. In these vehicles, usually the electric generator is also arranged to selectively operate as an electric motor for starting the internal-combustion engine, while the electric traction motor is also arranged to selectively operate as an electric braking generator for converting part of the kinetic energy of the vehicle into electric energy, charging the electric battery, during speed retardation or braking of the vehicle. Thus, the energy that is regenerated during frequent braking and the energy that is saved during frequent stops may outweigh the losses from the several conversions of the energy within the power train. Furthermore, the related environmental benefits may outweigh the concerns about the higher initial cost of the hybrid electric vehicle in comparison with the cost of an equivalent conventional vehicle driven by an internal-combustion engine.

Some examples of series hybrid electric vehicles are the disclosures in the U.S. Pat. No. 4,306,156 Monaco et al; U.S. Pat. No. 4,313,080 Park; U.S. Pat. No. 4,354,144 McCarthy; U.S. Pat. No. 4,533,011 Heidemeyer; and U.S. Pat. No. 4,951,769 Kawamura.

### The Parallel Hybrid Electric Vehicle

In the known parallel hybrid electric vehicles, typically the internal-combustion engine, operating at continuously variable torque-speed output, drives the electric generator, which in its turn charges the electric traction battery and supplies the electric traction motor with electric energy. At the same time, the internal-combustion engine also drives the two wheels of a drive axle through a multi-speed gear-shift transmission or a continuously-variable-speed transmission, and the final drive and differential of the drive axle. The electric traction motor is somehow mechanically connected in parallel with the internal-combustion engine to drive the wheels of the drive axle together with the internal-combustion engine when more power is demanded. Typically, the electric generator is also arranged to selectively operate briefly as an electric motor for starting the internal-combustion engine, and the electric traction motor is also arranged to selectively operate as an electric braking generator for recovering part of the kinetic energy of the vehicle during speed retardation or braking.

The major advantage of the parallel arrangement is that, at high power demand, the combined power outputs of the internal-combustion engine and electric traction motor are utilized to drive the vehicle. Therefore, the internal-combustion engine may be substantially smaller, in size and power, than the internal-combustion engine of a conventional vehicle having comparable performance characteristics, and the electric traction motor may be substantially smaller, in size and power, than the traction motor in a comparable electric vehicle or in a comparable series hybrid electric vehicle. The utilization of a smaller engine in the parallel arrangement results in some improvement in the fuel efficiency, particularly at higher vehicle speeds. That is another advantage of the parallel arrangement.

The major disadvantages of most of the parallel hybrid electric vehicles are their complicated power train, complicated control of continuously variable tractive and electric braking forces, and their higher cost, in comparison to these of the conventional vehicles or these of the series hybrid electric vehicles.

Different types of parallel arrangements are known, some of which are already incorporated in production hybrid electric vehicles.

### Parallel Arrangement with One Electric Machine

In some of the known parallel hybrid electric vehicles, an electric machine is mechanically coupled with the output shaft of the engine. The electric machine selectively operates as an electric starter motor, or an electric generator, or an electric traction motor. The mechanical energy from the engine and from the electric machine, when it operates as a traction motor, is transmitted to the drive axle of the vehicle through a multi-speed gear-shift transmission. At normal-load operation, the engine drives the vehicle and the electric machine, which, operating as an electric generator, charges an electric battery. At heavy-load operation, the engine and the electric machine, operating as a traction motor, drive the vehicle. When the electric machine operates as an electric traction motor or as a starter motor, it is powered by the battery. The backward motion of the vehicle is achieved through the reverse gear of the transmission. The control of the continuously variable tractive force of the vehicle is achieved via the conventional power transmission. The edition of the electric machine in the power train of the vehicle results in improvement of its performance characteristics. Such a parallel arrangement with one electric machine is relatively simple and less expensive than the other parallel arrangements.

On the other hand, since the engine operates continuously and within the entire engine speed range, and the mechanical energy from the engine and from the electric machine is transmitted to the drive axle through a multi-speed gear-shift transmission or a continuously-variable-speed transmission, the improvement in total fuel efficiency and performance characteristics is insignificant. It is questionable whether an insignificant improvement in fuel efficiency and performance would justify the higher cost of such type hybrid electric vehicles.

### Parallel Arrangement with Two Electric Machines

The power plants of other parallel hybrid electric vehicles incorporate two electric machines: an electric generator arranged also to selectively operate as an electric motor for starting the engine, and an electric traction motor arranged also to selectively operate as an electric braking generator for converting part of the kinetic energy of the vehicle into electric energy and charging the electric traction battery during speed retardation or braking of the vehicle. Most of the contemporary hybrid electric automobiles and particularly the hybrid electric passenger cars are of this kind. In these vehicles, the engine continuously drives the generator, which charges the battery and provides electric power for the traction motor, as well as for the other electric components and systems on board the vehicle. The generator operates briefly as an electric motor for starting the internal-combustion engine. The engine is connected with the generator through a mechanical drive train. In some cases, the output shaft of the engine is coaxial to and directly coupled or integrated with the input shaft of the generator.

Mechanical energy from the engine is transmitted to the wheels of a drive axle trough a multi-speed gear-shift transmission or a mechanical continuously-variable-speed transmission, and the final drive and differential of the drive axle. The output shaft of the traction motor is mechanically connected with the drive train between the transmission and the drive axle for transmitting mechanical energy from the traction motor to the wheels of the drive axle. The traction motor selectively drives the wheels of the drive axle in parallel with the engine. During vehicle speed retardation or braking, the kinetic energy from the wheels of the drive axle drives the rotor of the traction motor, which, now operating as an electric braking generator, converts part of the kinetic energy into electricity and charges the battery. This kind of hybrid electric vehicles have the advantages that while the engine and the electric motor (alternately or jointly) provide propulsion of the vehicle, the electric generator, driven by the engine, continually generates electric energy for powering the electric traction motor and charging the electric battery, when the battery is not sufficiently charged.

Regrettably, in this parallel arrangement too, while driving the vehicle, the engine operates within its entire rotational speed range, from its idle speed to its maximum speed, and the mechanical energy from the engine is transmitted to the wheels of the drive axle through a multi-speed gear-shift transmission or continuously-variable-speed transmission. The fuel economy and improvement in performance of this type of hybrid electric vehicles may not be substantial enough to compensate for their significantly higher cost in comparison with that of the conventional vehicles of the same class.

Some examples of parallel hybrid electric vehicles of the types discussed above are disclosed in the U.S. Pat. No. 3,566,717 Berman at al; U.S. Pat. No. 3,732,751 Berman et al; U.S. Pat. No. 4,165,795 Lynch et al; U.S. Pat. No. 4,305,254 Kawakatsu; U.S. Pat. No. 4,335,429 Kawakatsu; U.S. Pat. No. 4,405,029 Hunt; U.S. Pat. No. 4,407,132 Kawakatsu; U.S. Pat. No. 4,578,955 Medina; U.S. Pat. No. 5,117,931 Nishida; U.S. Pat. No. 5,120,282 Fjallstrom; U.S. Pat. No. 5,343,970 Severinsky; U.S. Pat. No. 5,586,613 Ehsani; U.S. Pat. No. 5,667,029 Urban et al; U.S. Pat. No. 5,704,440 Urban et al; U.S. Pat. No. 5,823,280 Lateur; U.S. Pat. No. 5,842,534 Frank; U.S. Pat. No. 5,845,731 Buglione et al; U.S. Pat. No. 6,018,198 Tsuzuki et al; U.S. Pat. No. 6,018,694 Egami et al; U.S. Pat. No. 6,209,672 Severinsky; U.S. Pat. No. 7,210,546 Kuang et al, and U.S. Pat. No. 7,214,156 Oliver.

### Parallel Arrangement with a Planetary-Gear-Type Mechanical-Energy-Mixing Device

Significant improvement in fuel efficiency an reduction of exhaust emissions in a parallel hybrid drive system have been achieved by replacing the torque converter and multi-speed gear-shift transmission or continuously-variable-speed transmission with a planetary-gear-type mechanical-energy-mixing device, known also as “power-split” or “power-distribution” device. Examples of hybrid electric vehicle with such a planetary-gear-type mechanism, mixing the flows of mechanical energy between the engine, generator, traction motor, and driving wheels of the vehicle are disclosed in U.S. Pat. No. 5,865,263 Yamaguchi et al, and U.S. Pat. No. 5,899,286 Yamaguchi et al. This type of hybrid power train is known in the art as Toyota Hybrid Synergy (THS) System.

In the THS System, which the author of this invention considers as most advanced prior art, the internal-combustion engine, the electric generator, the electric traction motor, and the planetary-gear-type device are coaxial, and are transversely located over the front axle of the vehicle. The planetary-gear-type device is sandwiched between the generator and the traction motor. The output shaft of the engine is coupled with the carrier of the planet gears, the shaft of the generator is coupled with the sun gear, and the shaft of the traction motor is coupled with the ring gear of the planetary-gear-type device. Thus, the shafts of the three major components of the hybrid power plant are mechanically connected, and the rotational behavior (speed and torque) of each of these components is directly related to the rotational behavior of each of the other two components. The mechanical energy is transmitted from the ring gear of the planetary-gear-type device to the wheels of the drive axle of the vehicle through a rigid drive train, including a two-stage gear speed reducer, an axle final drive and differential, and the axle wheels drive shafts. The planetary-gear-type device, gear speed reducer, and axle final drive and differential are integrated as a transaxle within a common enclosure. In this arrangement, as in most hybrid electric vehicles, the electric generator is arrange to selectively operate briefly as an electric starter motor for starting the engine, and the electric traction motor is arranged to selectively operate as an electric braking generator for speed retardation and braking of the vehicle with recovery of energy, which is often described as “regenerative braking”. The reverse motion of the vehicle is achieved by reversal of the direction of rotation of the electric traction motor. In this arrangement, the planetary-gear-type device acts as a continuously variable speed transmission.

Overall the mechanics of this arrangement is very simple and efficient. This is the major advantage of the Toyota THS System in comparison with the other known hybrid electric powertrains. The simplicity of the mechanics results in significant improvement of fuel efficiency.

On the other hand, the control of the tractive force by the accelerator pedal and the control of the braking force by the brake pedal are not direct, instant, and linear, because the continuously variable tractive and electric braking forces of the vehicle depend on the rotational behavior of the three power-generating components, connected mechanically by the planetary-gear-type device. In this arrangement, the electronics must continuously monitor and process a large number of variable parameters and must control the electric controllers of the engine, generator, and traction motor for simultaneously coordinating the rotational behavior of the engine, generator, and traction motor with the depression of the accelerator or brake pedal, respectively, for achieving the desired tractive or electric braking force. This system employs a very complicated and powerful electronics, and yet the regulation of the tractive and electric braking forces is not direct, instant, and linear. This is a major disadvantage of the Toyota THS System.

Most of the contemporary hybrid electric vehicles are equipped with anti-lock braking systems and anti-slip traction control systems for improving the safety when driving on slippery road surfaces. Most of the hybrid electric vehicles are also equipped with cruise speed control systems.

### Operational Control of the Parallel Hybrid Electric Vehicles

In all of the parallel hybrid electric vehicles described above, a central electronic controller usually continuously monitors, via appropriate sensors, the position of the vehicle directional control switch, depression of the accelerator pedal, depression of the brake pedal, speed and acceleration of the vehicle, and other variables depending on the specific design and method of driving and braking of the vehicle. The central electronic controllers processes the signals from the sensors and, in accordance with a predetermined program recorded within its memory, ultimately controls via respective controllers the operation of the internal-combustion engine, electric traction motor, electric generator, mechanical power transmission, and other devices included in the power train of the vehicle. The central electronic controllers coordinates the operation of the different components of the drive and braking systems in response to the control commands of the operator of the vehicle and in dependence on the variable parameters directly related to the operation of the respective components. It is quite obvious that the larger the number of the variable parameters the more complicated, expensive, and sluggish is the electronic control of the vehicle driving and braking. Other terms, such as “electronics”, “electronic controller”, “central controller”, “electronic module”, “microprocessor”, “vehicle computer”, etc. are used in the art to indicate a central electronic controllers such as the one briefly described herein above.

The latest remarkable success in the development of reliable alternating-current three-phase synchronous and three-phase asynchronous electric traction motors, as well as the availability of affordable, compact, sophisticated, and powerful vehicle electronics, have made possible the development of practical parallel hybrid electric vehicles.

### Series Arrangement Vs. Parallel Arrangement

Most of the mass produced passenger cars, sport-utility vehicles, light trucks, and buses operate in combined, city and highway, duty cycles.

Within a city limits, and during the traffic jams on the highways, which unfortunately are so frequent around the large cities and within the densely populated areas, the automobiles usually operate with relatively low speeds at frequent stop-and-go conditions. Most appropriate for such driving conditions, as far as fuel efficiency and exhaust emissions are concerned, are the hybrid automobiles with series arrangement of the power train. The internal-combustion engines of the series hybrid vehicles are usually narrow-speed-range machines with higher fuel efficiency than that of the comparable engines with wider speed range used in the conventional vehicles. In addition, in a series hybrid arrangement, the internal-combustion engine operates at a substantially constant speed within its optimum fuel-efficiency speed range, which further improves the total engine fuel efficiency.

On the other hand, the parallel hybrid electric vehicles are more appropriate for highway operational conditions, when the vehicles moves at relatively high speeds and high power demand, as far as fuel efficiency and performance are concerned. In the parallel arrangement, at relatively high speeds, usually the internal-combustion engine alone drives the vehicle at normal-load conditions (cruising), and both the internal-combustion engine and electric traction motor together drive the vehicle at heavy-load conditions (accelerating). Thus, the propulsion capabilities of the engine and traction motor are selectively used and combined for achieving high fuel-efficiency and performance at highway operational conditions.

The major disadvantages of the series arrangements (as discussed earlier) are their relatively large electric power plant (including the electric traction motor, capable to drive the vehicle within the entire vehicle speed range, and a relatively large electric battery) and the relatively low total fuel efficiency due to the several conversions of the energy generated by the internal-combustion engine. The major disadvantages of the parallel arrangements (as discussed earlier) are their relatively complicate, inefficient, and expensive mechanical power transmissions, and the complicated and expensive control of the continuously variable tractive and braking forces of the vehicle, which control is more or less not direct, instant, and linear.

The total fuel efficiency of a hybrid vehicle depends not only on the efficiency of the sources of mechanical energy but also on the efficiency of the transmission of mechanical energy from these sources to the driving wheels of the vehicle. Major disadvantage of most of the hybrid electric vehicles is their complicated, inefficient, and expensive drive train, usually including a torque converter, and a multi-speed gear-shift transmission or a mechanical continuously-variable-speed transmission. These are heavy, energy consuming, and expensive components.

The fuel efficiency and performance of the hybrid electric vehicle also depend very much on the accuracy and speed of the electronic control upon the generation and flow of mechanical and electrical energy within the power train of the vehicle. Exact, correctly programmed, and instant electronic control is essential for achieving high performance characteristics. If the power train of the vehicle is very complicated, the central electronic controllers has to monitor a large number of variable parameters, to process a large number of input signals, and to control a large number of electric control circuits, according to a very complicated program. The result is a very complicated, expensive, and more or less slower electronic control.

Therefore, it will be very beneficial if in a hybrid electric vehicle, which operates in combined city and highway conditions, the advantages of the series arrangement could be combined with the advantages of the parallel arrangement, and the disadvantages of both arrangements could be significantly reduced or eliminated, for achieving higher fuel-efficiency and performance than those of any one of these two arrangements.

It will be also very beneficial, if in a hybrid electric vehicle mechanical energy could be delivered from the sources of mechanical energy to the driving wheels of the vehicle via very simple and efficient drive trains, including no torque-converter, no multi-speed gear-shift transmission, no continuously-variable speed transmission, no planetary-gear-type mechanical-energy-mixing mechanism, or other heavy, inefficient, and expensive components.

It will be further very beneficial, if in a hybrid electric vehicle the power train could be so arranged that the electronics would have to monitor a small number of variables and to control very small number of simple electric control circuits for providing direct, instant, and linear control of the tarctive and braking forces of the vehicle in response to the depression of the accelerator pedal or brake pedal respectively.

### SUMMARY OF THE INVENTION

This invention provides a hybrid electric vehicle including an exceptionally simple and efficient combined series/parallel drive system capable to drive the vehicle:
via an electric traction motor from standstill to a certain predetermine medium speed of the vehicle in a forward/low-speed drive mode;
via an internal-combustion engine above the predetermined medium speed of the vehicle under normal load in a forward/high-speed/normal-load drive mode;
via both the internal combustion engine and the electric traction motor above the predetermined medium speed of the vehicle under heavy load in a forward/high-speed/heavy-load drive mode; and
via the electric traction motor backward in a reverse drive mode.

The vehicle according to this invention operates as a series hybrid electric vehicle when moving with relatively low speeds (lower than the predetermined medium speed), and as a parallel hybrid electric vehicle when moving with relatively high speeds (higher than the predetermined medium speed). Thus, the invention combines the advantages of the series arrangement (which are substantial when the vehicle operates in cities or other densely populated areas and moves with relatively low speeds at frequent stop-and-go operational conditions) with the advantages of the parallel arrangement (which are substantial when the vehicle move with relatively high-speeds at highway operational conditions, where the power demand may be very high) in terms of fuel-efficiency, exhaust emissions, and performance. This is one of the major advantages of this invention over the prior art.

The hybrid electric vehicle according to this invention comprises:
a first axle including two driving wheels and a second axle including two free-rolling wheels, wherein said wheels of at least one of said two axles are also steerable for steering the vehicle;
an electric traction motor for selectively driving the wheels of said first axle, wherein the direction of rotation of said electric traction motor is reversible;
a first mechanical drive train for transmitting mechanical energy between the electric traction motor and the driving wheels of the first axle;
an electric power source for supplying the electric traction motor with electric energy, said electric power source including an electric traction battery for storing electric energy and selectively powering the electric traction motor and an electric generator for selectively powering the electric traction motor and charging said electric battery;
an internal-combustion engine for selectively driving said electric generator or the electric generator and the driving wheels of the first axle;
a second mechanical drive train for transmitting mechanical energy between said internal-combustion engine and the driving wheels of the first axle;
a clutch included in said second mechanical drive train for selectively interrupting the transmission of mechanical energy between the internal-combustion engine and the driving wheels of the first axle;
a third mechanical drive train for transmitting mechanical energy between the internal-combustion engine and the electric generator; and
a central electronic controller arranged and programmed to control and coordinate the operation of the clutch, electric traction motor, and internal-combustion engine for operating the vehicle in different drive modes.

The hybrid electric vehicle according to the present invention operates in:
(a) a forward/low-speed drive mode, wherein at speeds of the vehicle lower than a predetermined speed said clutch is disengaged, the electric traction motor alone drives the driving wheels of the first axle, and the internal-combustion engine drives the electric generator or rests;
(b) a forward/high-speed/normal-load drive mode, wherein under normal load at speeds of the vehicle higher than said predetermined speed the clutch is engaged, the internal-combustion engine alone drives the driving wheels of the first axle while also driving the electric generator, and the electric traction motor dose not operate;
(c) a forward/high-speed/heavy-load drive mode, wherein under heavy load at speeds of the vehicle higher than the predetermined speed the clutch is engaged and both the internal-combustion engine and the electric traction motor together drive the driving wheels of the first axle; and
(d) a reverse drive mode, wherein the clutch is disengaged, the direction of rotation of electric traction motor is reversed, the electric traction motor alone drives the driving wheels of the first axle, and the internal-combustion engine drives the electric generator or rests.

The power train of the hybrid electric vehicle according to this invention does not include any torque converter, multi-speed gear-shift transmission, continuously-variable-speed transmission, or other complicated, heavy, noisy, energy-consuming, and expensive components, which are typically used in the conventional and in the known hybrid electric vehicles. Here, the mechanical power flows via very simple end efficient mechanical drive trains. The simplicity of the mechanics, according to this invention, is remarkable. This simplicity results in better fuel efficiency and in lower cost of the vehicle according to this invention, in comparison to those of the known hybrid electric vehicles.

This Invention provides a hybrid electric vehicle with a very simple and inexpensive operational control capable of coordinating the operation of the clutch, electric generator, internal-combustion engine, and traction motor, and the charging of the electric battery, for achieving high total fuel efficiency and high performance characteristics of the vehicle, under all driving conditions. The control of the operation of the vehicle is such that the internal-combustion engine never idles and never operates with rotational speeds lower than a predetermined rotational speed within its optimum fuel-efficiency speed range, therefore providing high engine fuel efficiency.

The operational control of the vehicle according to this invention provides a very smooth automatic shifting from said forward/low-speed drive mode to one of said two forward/high-speed drive modes or vise versa, depending only on the speed of the vehicle, as well as a very smooth automatic shifting from the forward/high-speed/normal-load drive mode to the forward/high-speed/heavy-load drive mode and vice versa, depending only on the external load.

In some embodiments of this invention the electric generator is further arranged to selectively operate as an electric motor powered by the electric battery for starting the internal-combustion engine.

Some embodiments of the vehicle according to this invention further comprise:
an electrically controllable clutch actuator for engaging or disengaging said clutch;
a generator controller for automatically controlling the operation of the electric generator, and further arrange to selectively operate the electric generator as an electric motor, wherein the operation of the electric generator as an electric motor is electrically controllable;
an electrically controllable internal-combustion engine controller for operating the internal-combustion engine;
an electrically controllable electric traction motor controller for operating the electric traction motor;
an electrically controllable electric battery charger for selectively connecting or disconnecting electrically the generator controller, the electric battery, and the traction motor controller to or from each other respectively;
a directional mode control switch controllable by the operator of the vehicle for pre-selecting the forward or reverse directional mode of the vehicle;
an accelerator pedal controllable by the operator of the vehicle for providing control of the continuously-variable tractive force of the vehicle, and
a steering wheel controllable by the operator of the vehicle for varying the steering angle of said steering wheels of the vehicle.

Also, in some embodiments of the present invention, the central electronic controller is arranged to continuously monitor the direction of motion, speed, and acceleration of the vehicle, the depression of the accelerator pedal, the rotational output speed of the engine, the state of charge of the electric battery, and the magnitude of the electric current drawn from the electric battery, and to control the clutch actuator, generator controller, traction motor controller, engine controller and electric battery charger, for operating the respective components and the charging of the electric battery according to a predetermined program.

In some embodiment of this invention the central electronic controller is programmed:
(a) to disengage the clutch and to keep the clutch disengaged, when the vehicle is not moving, when the vehicle is moving forward with a speed lower than a first predetermined speed, and when the vehicle is moving backward;
(b) to start the engine by momentarily operating the generator as an electric motor, if the engine is not already running, and to operate the engine at a substantially constant rotational speed within its optimum fuel-efficiency speed range, when the vehicle is not moving, when the vehicle is moving forward with a speed lower than said first predetermined speed, and when the vehicle is moving backward, only if any of the following conditions is detected: (i) the charge of the electric battery is lower than a predetermined low level, (ii) the electric current drawn from electric battery is stronger than a predetermined electric current, and (iii) the speed of the vehicle is between said first predetermined speed and a slightly lower second predetermined speed;
(c) to stop the operation of the engine, if the engine is already running, when the vehicle is not moving and the charge of the electric battery is higher than said predetermined low level;
(d) to stop the operation of the engine, if the engine is already running, when the vehicle is moving forward with speeds lower than said second predetermined speed or when the vehicle is moving backward, if the charge of the electric battery is higher than a predetermined high level and the electric current drawn from the electric battery is weaker than said predetermined electric current;
(e) to operate the engine at continuously variable torque-speed output in response to the depression of the accelerator pedal when the vehicle is moving forward at speeds higher than the first predetermined speed;
(f) to operate the traction motor at continuously variable torque-speed output in response to the depression of the accelerator pedal when the vehicle is moving forward with speeds lower than the first predetermined speed and when the vehicle is moving backward;
(g) to disconnect the traction motor from the electric power source regardless of the depression of the accelerator pedal when the vehicle is moving forward at speeds higher than the first predetermined speed and the internal-combustion engine alone is capable of driving the electric generator and of sustaining the vehicle speed or of accelerating the vehicle to a higher desirable speed in response to the depression of the accelerator pedal;
(h) to disconnect the electric generator controller from the electric battery and from the traction motor controller, to connect traction motor controller to the electric battery, and to operate the traction motor at continuously variable torque-speed output in response to the depression of the accelerator pedal, when the vehicle is moving forward with speeds higher than the first predetermined speed and the engine alone is not capable of sustaining the vehicle speed or of accelerating the vehicle to a higher speed in response to the depression of the accelerator pedal; and
(i) to disconnect the electric battery from the electric generator controller when the engine operates and the charge of the electric battery is higher than the predetermined high level.

This invention provides a hybrid electric vehicle with instant, direct, and linear control of the tractive force under all driving conditions, within the entire speed range of the vehicle. The continuously variable torque-speed output of the traction motor (when the traction motor alone drive the vehicle in said forward/low-speed drive mode or in said reverse drive mode), the continuously variable torque-speed output of the engine (when the engine alone drive the vehicle in said forward/high-speed/normal-load drive mode), and the continuously variable torque-speed output of both engine and traction motor (when these two sources of mechanical energy together drive the vehicle in said forward/high-speed/heavy-load drive mode) are controlled only by the depression of the accelerator pedal. This direct, instant, and linear control of the tractive force is another of the major advantages of the present invention over the prior art, and particularly over the hybrid electric vehicles employing a planetary-gear-type mechanical-energy-mixing devices.

This invention further provides a hybrid electric vehicle with a safe braking system. In some embodiments of the vehicle according to this invention, the braking system is capable of selectively converting part of the kinetic energy of the vehicle into electric energy charging the electric battery during speed retardation or braking of the vehicle. This invention provides direct, instant, and linier control of the braking force.

Therefore, in some embodiment of the vehicle according to this invention, the traction motor is further arranged to selectively operate as an electric braking generator driven by the kinetic energy of the vehicle and the kinetic energy of the first drive trains, and the traction motor controller is further arranged to selectively operate the traction motor as an electric braking generator for converting part of said kinetic energy into electric energy charging the electric battery during speed retardation or braking of the vehicle. The operation of the dual-rotor motor as an electric braking generator is electrically controllable.

The operation of the traction motor as an electric braking generator is coordinated with the operation of conventional wheel brakes for providing maximum regeneration of electric energy with high braking performance and safety under all driving conditions. Therefore, some embodiments of the vehicle according to this invention further comprise: wheel brakes for braking the wheels of the vehicle; an electrically controllable wheel brakes actuator for selectively applying said wheel brakes; and a brake pedal controllable by the operator of the vehicle for providing continuously variable control of the braking force of the vehicle.

This invention provide a hybrid electric vehicle with safe, direct, instant, and linier control of the braking force. Therefore, in some embodiments of a vehicle according to the present invention, the central electronic controller is further arranged to continuously monitor the depression of said brake pedal, the steering angle of the said steering wheel, and the rotational speeds of each of the wheels of the vehicle. The electronics is further arranged to control the operation of said wheel brakes via the wheel brakes actuator and the operation of the traction motor as an electric braking generator according to a predetermined program.

Therefore, in some embodiments of a vehicle according to this invention, the central electronic controller is further programmed to do the following:
(a) When the vehicle is moving forward with a speed lower than the first predetermined speed, the accelerator pedal is not depressed, and an acceleration of the vehicle is detected to operate the traction motor as an electric braking generator for maintaining the speed of the vehicle substantially constant and charging the electric battery;
(b) When the vehicle is moving forward with a speed higher than the first predetermined speed, the accelerator pedal is not depressed, and an acceleration of the vehicle is detected:
   to disengage the clutch;
   to operate the engine at the substantially constant speed within its optimum fuel-efficient speed range; and
   to operate the traction motor as an electric braking generator for maintaining the speed of the vehicle substantially constant and charging the electric battery;
(c) When the vehicle is moving forward with a speed lower than the first predetermined speed and the brake pedal is depressed:
   to operate the traction motor as an electric braking generator when in response to the depression of the brake pedal the traction motor alone, while charging the electric battery, provides a continuously variable braking force capable of sustaining the vehicle speed during speed retardation or of decelerating the vehicle to a lower desirable speed during braking;
   to operate the traction motor as an electric braking generator and, when in response to the depression of the brake pedal the traction motor alone does not provide a continuously variable braking force capable of sustaining the vehicle speed during speed retardation or of decelerating the vehicle to a lower desirable speed during braking, to gradually apply the wheel brakes increasing in a predetermined very short period of time their braking force from zero to a braking force corresponding to the depression of the brake pedal, and then to control the continuously variable braking force of the wheel brakes in response to the depression of the brake pedal;
   to discontinue the operation of the traction motor as an electric braking generator regardless of the depression of the brake pedal and to brake the vehicle via the wheel brakes in response to the depression of the brake pedal when differences between the rotational speeds of the wheels of the vehicle larger than respective predetermined differences are detected, wherein said predetermined speed differences vary with the variation of the steering angle of the vehicle steering wheels; and
   to brake the vehicle via the wheel brakes in response to the depression of the brake pedal when the electric battery is fully charged;
(d) When the vehicle is moving forward with a speed higher than the first predetermined speed and the brake pedal is depressed:
   to disengage the clutch;
   to operate the engine at the predetermined substantially constant speed within its optimum fuel-efficiency speed range;
   to operate the traction motor as an electric braking generator when in response to the depression of the brake pedal the traction motor alone provides a continuously variable braking force capable of sustaining the vehicle speed during speed retardation or of decelerating the vehicle to a lower desirable speed during braking, while charging the electric battery;
   to operate the traction motor as an electric braking generator and, when in response to the depression of the brake pedal the dual-rotor motor alone does not provide a continuously-variable braking force capable of sustaining the vehicle speed during speed retardation or of decelerating the vehicle to a lower desirable speed during braking, to gradually apply the wheel brakes increasing in a predetermined very short period of time their braking force from zero to a braking force corresponding to the depression of the brake pedal, and then to control the continuously variable braking force of the wheel brakes in response to the depression of the brake pedal;
   to discontinue the operation of the traction motor as an electric braking generator regardless of the depression of the brake pedal and to brake the vehicle via the wheel brakes in response to the depression of the brake pedal when differences between the rotational speeds of the wheels of the vehicle larger than respective predetermined differences are detected, wherein the predetermined speed differences vary with the variation of the steering angle of the vehicle steering wheel; and
   to brake the vehicle via the wheel brakes in response to the depression of the brake pedal when the electric battery is fully charged; and
(e) When the vehicle is not moving or is moving backward to apply the wheel brakes in response to the depression of the brake pedal.

These and other advantages of this invention over the prior art will become apparent from the following description and the accompanying drawings.

### BRIEF DESCRIPTION OF THE DRAWINGS

FIG. 1 is a schematic illustration of a first embodiment of a vehicle according to this invention.

FIG. 2 is a schematic illustration of a second embodiment of a vehicle according to this invention.

FIG. 3 is a schematic illustration of a third embodiment of a vehicle according to this invention.

FIG. 4 is a schematic illustration of a fourth embodiment of a vehicle according to this invention.

### DETAILED DESCRIPTION OF THE INVENTION

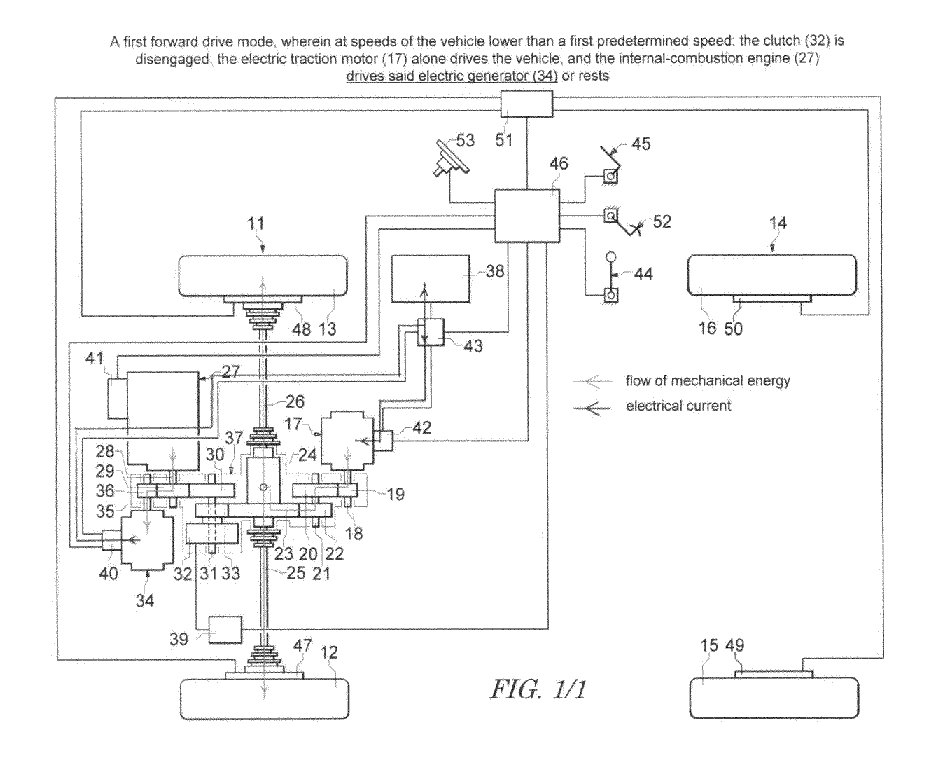

In each of the figures, illustrating different embodiments of this invention, the same components are designated by the same numbers. Here, the term “same component” means that the component performs the same functions and is in the same relationships with the other components, which functions and relationships are relevant to this invention, as they are described initially hereinafter in this detailed description. For example, the internal-combustion engine, which appears in all figures, is described initially with FIG. 1 and is designated by number 27. In all other figures the internal-combustion engine is designated by the same number 27.

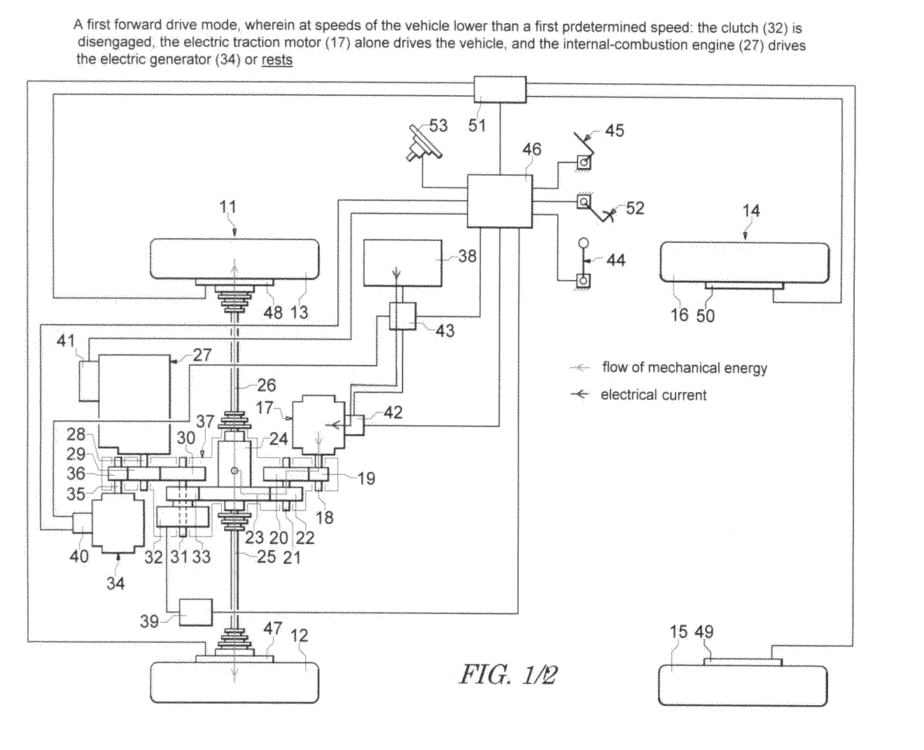

The mechanical components are shown very schematically as in views or cross sections unfolded into the plane of the drawing. The electrical components, controllers, and actuators are shown schematically as in a block diagram. The relationships between some of the components are shown with single lines regardless of how complicated these relationships might be in reality. For simplicity and clarity, no details irrelevant to the understanding of this invention are shown or described. For the same reason, some well known in the art components are mentioned but are not shown or are shown but are not described in detail. In the descriptions of the embodiments of this invention illustrated by FIG. 2 to FIG. 4, only what is different in comparison with the first embodiment illustrated by FIG. 1 is briefly described.

Referring to FIG. 1, a first axle 11 having two driving wheels 12, 13 and a second axle 14 having two free-rolling wheels 15, 16 are suspended to the frame of the vehicle in a suitable manner known in the art. In this invention the term “frame” is used to indicate the strong and rigid structural body of the vehicle that carries the loads and transfers them upon the wheels of the vehicle, to which body the static enclosures of the major components of the vehicle power train are normally firmly attached. In this invention the term “axle” is used to indicate the combination of components rotatably supporting each pair of vehicle wheels. Whether the wheels of the vehicle are independently suspended to the frame or are suspended via a rigid body (axle or axle enclosure) is irrelevant for this invention. The wheels of at least one of said two axles are also steerable for steering the vehicle. For simplicity of drawing and description, the frame of the vehicle, suspensions of axles and wheels, and arrangement of steering of the steerable wheels are not shown.

An electric traction motor 17 is located close to the first axle 11 in a transversal configuration. A first mechanical drive train connects the traction motor with the driving wheels 12, 13 of the first axle for transmitting mechanical energy between the traction motor and the driving wheels of the first axle. In this embodiment, an output shaft 18 of the traction motor 17 is coupled with a small gear 19, which is engaged with a larger gear 20 coupled with a drive shaft 21. Another small gear 22 is also coupled with drive shaft 21 and is engaged with a large crown gear 23 of a drive axle differential 24. The described arrangement is actually a two-stage gear speed reducer. In this description the term “gear” is used to indicate a toothed gear. The differential may be a conventional differential or a limited-slip differential of a known appropriate type. Two wheel shafts 25, 26 connect two output gears of the differential 24 with the driving wheels 12, 13 of the first axle respectively. For simplicity of drawing and description the details of the differential, including said two output gears, are not shown. It is well known in the art, however, that the differential branches the drive train towards the two wheels of the drive axle, and allows these two wheels to rotate with different speeds depending on the external forces resisting the rotation of each wheel.

In the described first mechanical drive train, all components transmitting mechanical energy are constantly engaged respectively as described and always rotate in unison. The drive train provides a single speed-reduction ratio.

An internal-combustion engine 27 is the prime source of mechanical energy on board the vehicle. Herein after, for abbreviation of this description, the shorter term “engine” is frequently used instead of the term “internal-combustion engine”. In this embodiment, the engine 27 is transversely situated, in parallel with the traction motor 17. A second mechanical drive train connects the engine with the driving wheels 12, 13 of the first axle for transmitting mechanical energy between the engine and the driving wheels of the first axle. In this embodiment, an output shaft 28 of the engine is coupled with gear 29, which is engaged with a gear 30 coupled with a clutch shaft 31. A clutch 32 is included in the second drive train for selectively interrupting the transmission of mechanical energy between the internal-combustion engine 27 and the driving wheels 12, 13 of the first axle. The clutch is shown as in a block diagram and its specific type and design are not further discussed or claimed. In this embodiment, it is assumed that when the clutch 32 is engaged a clutch gear 33 is coupled with the clutch shaft 31, and when the clutch 32 is disengaged the clutch gear 33 is not coupled with the clutch shaft 31 and may rotate freely upon the clutch shaft. The clutch gear 33 is engaged with the crown gear 23 of the differential 24. Thus, when the clutch is engaged, mechanical energy is transmitted between the engine and the driving wheels of the first axle through the engine output shaft 28, gears 29 and 30, clutch shaft 31, clutch gear 33, crown gear 23, differential 24 and the driving wheel shafts 25, 26. When the clutch is disengaged, the transmission of mechanical energy between the clutch shaft and clutch gear is interrupted, and therefore, the transmission of mechanical energy between the internal-combustion engine and the wheels of the first axle is interrupted. In the hybrid electric vehicles, usually a damper-coupling connects the engine crankshaft to the engine output shaft for avoiding shocks during the start of the engine. For simplicity, however, no details of the engine, but its main output shaft 28, are shown.

In the described second mechanical drive train, when the clutch is engaged all components transmitting mechanical energy are constantly engaged respectively as described and always rotate in unison. The second drive train provides a single speed-reduction ratio.

An electric generator 34 is a prime source of electric energy on board the vehicle. In this embodiment the electric generator is transversely located in parallel with the engine. An input shaft 35 of the electric generator extends towards the engine. Hereinafter, for abbreviation of this description, the shorter term “generator” is frequently used instead of the term “electric generator”. A third mechanical drive train connects the engine 27 with the generator 34 for transmitting mechanical energy between the engine and the generator. In this embodiment, the gear 29 coupled with the output shaft 28 of the engine is engaged with a smaller gear 36 coupled with an input shaft 35 of the generator. Actually, the described arrangement is a single-stage gear drive. Such an arrangement is needed when the efficient operational speed range of the electric generator is higher than the efficient operational speed range of the internal-combustion engine. It is obvious that in this embodiment the engine output shaft 28 and gear 29 are parts of both second and third drive trains. This, however, is only one of many possible arrangements of the third mechanical drive train. In the third mechanical drive train, all components transmitting mechanical energy are constantly engaged and always rotate in unison. This third drive train provides a single speed-reduction ratio.

In this embodiment, all components of the first, second, and third drive trains, with the exception of the wheel shafts 25, 26, are enclosed and supported rotatably within a transmission/axle (transaxle) enclosure 37 in an appropriate manner. Though the transaxle enclosure may be composed of several parts firmly attached to each other, for simplicity and clarity of the drawing, it is schematically shown with a fine line as a single body in an unfolded cross-section. Although gaps between the transaxle enclosure 37 and the traction motor, engine, and generator respectively are shown for clarity, it is assumed that the traction motor, engine, and generator are firmly attached to the transaxle enclosure. It is assumed that the entire block composed of engine, transaxle enclosure, traction motor, and generator is appropriately attached firmly to the frame of the vehicle. For simplicity of drawing and description, the fastening of this block to the frame is not shown.

In this embodiment, it is assumed that the driving wheels 12, 13 are independently suspended to the frame of the vehicle in some appropriate manner, and each of the wheel shafts 25, 26 is actually an assembly of shafts and constant-velocity joints allowing vertical motion of the respective wheel and steering motion if the wheel is also steerable, while transmitting mechanical energy to or from the driving wheel.

A high-voltage electric traction battery 38 stores electric energy on board the vehicle. When the engine operates, it drives the generator 34, which selectively charges said electric traction battery when the battery is not sufficiently charged, and supplies the traction motor 17 with electric energy when the traction motor operates. The electric traction battery selectively powers the traction motor, and also may supply with electric energy other electric component and systems of the vehicle via appropriate electric devices and circuits. Both the generator and electric traction battery are the source of electric energy on board the vehicle. Hereinafter, for abbreviation of this description, the shorter term “electric battery” is frequently used instead of the term “electric traction battery”.

In this invention, the term “sufficiently charged”, referring to the state of charge of the electric battery, indicates that the electric charge of the battery is between a predetermined high level and a predetermined low level. The high level of charge is lower than the state when the battery is fully charged, and the low level of charge is higher than the state when the battery is fully discharged. A vehicle according to this invention is arranged to operate preferably when the electric battery is sufficiently charged. Therefore, the charging of the battery with electric energy from the generator is initiated when the battery is at its low charge level and is terminated when the battery is at its high charge level, as it is herein later described.

A clutch actuator 39 engages or disengages the clutch 32. The specific arrangement of the clutch actuator depends on the specific type and design of the clutch. For example, if the clutch is a fluid-pressure operated frictional-discs clutch, then the clutch actuator shall include at least a source of fluid pressure and an electromagnetic fluid-pressure directional-control valve. In any case, however, the clutch actuator is electrically controllable. The clutch actuator is shown as in a block diagram, and the relationship between the clutch and clutch actuator is indicated by single line. The clutch actuator 39 may be further arranged to automatically engage the clutch 32 when the vehicle is parked and the electric control of the clutch actuator is terminated. Thus, the internal-combustion engine will provide a vehicle motion resisting force when the vehicle is parked.

An electric generator controller 40 is provided for automatically controlling the operation of the electric generator 34, including the functions related to the proper and safe operation of the generator, charging of the battery, and supplying of the traction motor with electric energy, for example such functions being voltage regulation, over-voltage protection, protection from current flowing back from the electric battery when the generator does not operate, rectification of the electric current if the generator is an alternating-current machine, etc. Because those automatically controlled functions depend on the specific kind and design of the generator, traction motor, and battery, they are not further discussed or claimed specifically. Hereinafter, for abbreviation of this description, the term “generator controller” is frequently used instead of the term “electric generator controller”.

In some embodiments of the invention (as in this one), the electric generator 34 is further arranged to selectively operate as an electric motor powered by the battery 38, and the generator controller 40 is further arranged to selectively operate the generator as an electric motor for starting the internal-combustion engine 27, wherein the operation of the electric generator as an electric motor is electrically controllable.

An internal-combustion engine controller 41 operates the internal-combustion engine 27. The internal-combustion engine controller operates the engine devices, which in a conventional engine operating system are operable by the accelerator pedal of the vehicle. The internal-combustion engine controller 41 controls the continuously variable fuel intake and air intake of the internal combustion engine, and may control other functions which are directly related to the continuously variable torque-speed output of the internal-combustion engine, such as a variable valve timing, or a variable ignition timing, etc. The internal-combustion engine controller is also arranged to selectively stop the operation of the engine. The internal-combustion engine controller is electrically controllable. Hereinafter, for abbreviation of this description, the shorter term “engine controller” is frequently used instead of the term “internal-combustion engine controller”.

A traction motor controller 42 operates the traction motor 17. The traction motor controller 42 is arranged to selectively render the traction motor operable in direction of rotation corresponding to a forward drive mode of the vehicle, or in directions of rotation corresponding to a backward drive mode of the vehicle, or to disconnect the traction motor from said electric power source and to render the traction motor inoperable in a neutral drive mode. The selection of either one of said three directional drive modes is electrically controllable. The traction motor controller is further arranged when the traction motor is operable to control the magnitude of the electric power input to the traction motor for providing continuously variable torque-speed output from the traction motor, wherein the control of the torque-speed output of the traction motor is electrically controllable.

The generator controller 40, engine controller 41, and traction motor controller 42 are shown attached to the generator, engine, and traction motor respectively. This is made, however, for simplicity of drawing and description. The specific locations of these three components are irrelevant fort the purpose of this invention.

An electric battery charger 43 electrically connects the generator controller 40, the battery 38, and the traction motor controller 42 to each other respectively through appropriate electrical power circuits. For simplicity of drawing and description, the electrical connections between the generator controller, traction motor controller, battery, and battery charger are represented by single lines. Said electric battery charger 43 is arranged to selectively disconnect the generator controller, battery, and traction motor controller from each other respectively, wherein said selective disconnections are electrically controllable. It is obvious for the skilled in the art that the generator controller 40 may be arranged for selectively disconnecting simultaneously the generator from the battery and from the traction motor controller, and that the traction motor controller may be arranged for selectively simultaneously disconnecting the traction motor from the generator controller and from the battery. If the generator controller and the traction motor controller are so arranged, then the battery charger 43 is arranged to selectively disconnect only the battery from the generator controller and from the traction motor controller respectively.

When the generator is disconnected from the battery and from the traction motor, no electric current flows through the generator, although the internal-combustion engine may drive the generator, and when the traction motor is disconnected from the battery and from the generator, no electric current flows through the traction motor, although the vehicle may be moving and the traction motor may be rotating.

The battery charger 43 may be further arranged to charge the battery from an external source of electric energy when the vehicle is parked. Said external source of electric energy may be the common household electric grid, or another appropriate external electric power source. A cable with electric receptacle and plug connects the battery charger to the outlet of the external electric power source. For simplicity of drawing and description, these details are not shown or claimed.

The electrically controllable controllers and actuators, such as the described herein above, usually include electro-mechanical devices, such as linear or angular servo-motors, electromagnetic valves, electromagnets, etc., and electrical control circuits, capable of responding accordingly to electrical input signals. In this invention, the controllers and actuators are shown symbolically as in a block diagram, and no their details are described or claimed.

A directional mode control switch 44, which is usually a lever-switch, is provided for pre-selection of the desired directional modes of the vehicle. The operator of the vehicle pre-selects a forward drive mode preparing the electric traction motor for driving the vehicle forward, or a backward drive mode preparing the traction motor for driving the vehicle backward, or a neutral drive mode rendering the traction motor not operable, by placing said directional mode control switch 44 in a forward, or a backward, or a neutral drive position respectively. The positions of the directional mode control switch are self-locked for preventing unintentional changing of the directional drive mode.

An accelerator pedal 45 is provided for controlling the continuously variable tractive force of the vehicle. The operator of the vehicle controls the continuously variable tractive force by varying the depression of the accelerator pedal 45. The accelerator pedal is arranged to resist the depression, usually via a spring, wherein the resisting force is proportional to the depression, for providing the operator of the vehicle with an appropriate control feeling. In this invention, the term “tractive force” refers to the sum of the tractive forces of the two driving wheels. It is obvious for the skilled in the art that, instead of by a pedal, the tractive force may be controlled manually by an accelerator lever, as it is, for example, in vehicles for some physically disabled operators. In this invention, the term “accelerator pedal” refers to the device that the operator uses to control the tractive force, and no details of the accelerator pedal are described or claimed.

A central electronic controller 46 is arranged to continuously monitor, through several sensors, the speed and acceleration of the vehicle, the rotational output speed of the internal-combustion engine 27, the position of the directional mode control switch 44, the depression of the accelerator pedal 45, the state of charge of the electric battery 38, and the magnitude of the electric current drawn from the electric battery. The sensors are not shown for simplicity of drawing and description. The central electronic controller 46 is arranged to process the input signals from the sensors and to generate output signals for controlling the clutch actuator 39, generator controller 40, engine controller 41, traction motor controller 42, and battery charger 43 respectively, in accordance with a predetermined program. The central electronic controllers is also arranged to control time-related functions which are described herein later.

Ultimately, the central electronic controller 46 controls the operation of the clutch 32, generator 34, engine 27, traction motor 17, and the charging of the battery 38, in accordance with the monitored variable parameters and said predetermined program, which program is described in details herein later. Whether the central electronic controller is a compact electronic device with integrated electronic circuits, or several electronic devices operating in unison and performing the described herein functions, is irrelevant for the purpose of this invention. The physical locations of the components of the central electronics controller are also irrelevant for the purpose of this invention. The central electronic controller 46 is shown as in a block diagram. Single lines indicate the relationships of the central electronic controller with the clutch actuator 39, each of the controllers 40, 41, 42, battery charger 43, directional mode control switch 44, and accelerator pedal 45 respectively. For abbreviation of this description, the term “electronics” is frequently used hereinafter instead of the term “central electronic controller”.

In the description of this invention, the terms “speed of the vehicle” and “acceleration of the vehicle” indicate the magnitude of the speed of the vehicle and the magnitude of the tangential acceleration of the vehicle (i.e. the change of the magnitude of the speed of the vehicle), respectively.

The vehicle according to this invention is further equipped with a safe braking system, including wheel brakes 47, 48, 49, 50, for braking the rotation of the respective wheels 12, 13, 15, 16 of the vehicle, an electrically controllable wheel brakes actuator 51 for operating said wheel brakes, and a brake pedal 52 controllable by the operator of the vehicle for providing continuously variable control of the braking force of the vehicle by varying the depression of said brake pedal. The wheel brakes are usually required by law.

In this embodiment of the invention, for the purpose of providing electric braking with recovery of energy, the traction motor 17 is further arranged to selectively operate as an electric braking generator. The traction motor controller 42 is further arranged to selectively operate the traction motor as an electric braking generator, wherein the operation of the traction motor as an electric braking generator is electrically controllable. During speed retardation or braking of the vehicle, kinetic energy transmitted from the driving wheels through the first drive train to the traction motor, drives the traction motor, which operating as an electric braking generator brakes the vehicle while generating electric energy and charging the electric battery. The traction motor controller is arranged to automatically perform the functions related to the proper and safe operation of the traction motor and charging of the electric battery. Because those automatically controlled functions depend on the specific kind and design of the traction motor and the battery, they are not further discussed or claimed specifically. The traction motor controller is further arrange to control the magnitude of the electric power output from the traction motor for providing continuously variable control of the electric braking force.

In this specification of the invention, the term “braking force” refers to the sum of the braking forces of the four wheels, unless the braking force of any specific wheel or wheels respectively are otherwise specified. The operator of the vehicle controls the continuously variable braking force by varying the depression of the brake pedal 52. The braking force is substantially proportional to the depression of the brake pedal. The brake pedal is arranged to resist the depression, usually via a spring, wherein the resisting force is proportional to the depression, for providing the operator of the vehicle with an appropriate control feeling. It is obvious for the skilled in the art that, instead of by a pedal, the braking force may be controlled manually by a brake lever, as it is, for example, in vehicles for some physically disabled operators. In this invention, the term “brake pedal” refers to the device that the operator uses to control the braking force, and no details of the brake pedal are described or claimed.

In this embodiment, a controllable by the operator of the vehicle steering wheel 53 is provided for varying the steering angle of said steerable wheels of at least one of the axles. For simplicity, no other elements of the vehicle steering system are shown or described.

The electronics 46 is further arranged to continuously monitor, through several sensors, the depression of said brake pedal 52, the steering angle of a vehicle steering wheel 53, and the rotational speeds of the wheels 12, 13, 15, 16 of the vehicle. For achieving safe braking, the electronics is arrange to control the operation of the traction motor as an electric braking generator, and to coordinate its operation with the operation of said wheel brakes actuator 51 in accordance with a predetermined program, which program is described in details herein later.

The relationships of the electronics 46 with the brake actuator 51, brake pedal 52, and steering wheel 53 are indicated respectively by single lines. The relationships between the brake actuator 51 and the wheel brakes 47, 48, 49, 50 are indicated respectively by single lines. The specific arrangement of the wheel brakes actuator depends on the specific type of the wheel brakes and the method of their operation. Usually the wheel brakes are fluid-pressure operated, and the wheel brakes actuator includes a source of fluid pressure and fluid-pressure-modulating valves. The wheel brakes actuator may be a conventional brake actuator, or a brake actuator including an anti-lock braking system for preventing lockup of any one of the driving wheels of the vehicle. For simplicity of drawing and description, the wheel brakes and wheel brakes actuator are shown as in a block diagram, and no their details are described or specifically claimed.

The braking forces generated by the traction motor (when it operates as an electric braking generator) and transmitted to the driving wheels of the vehicle cannot be individually modulated. On the other hand, the braking force of each of the wheel brakes can be individually modulated via a brake actuator including an anti-lock braking system for preventing lockup of any one of the wheels of the vehicle. In any embodiment, however, wherein the traction motor is arranged to selectively provide electric braking, the electronics is programmed to coordinate the operation of the traction motor with that of the wheel brakes for safe braking of the vehicle, as herein later described.

If the wheel brakes actuator 51 includes an anti-lock braking system, then an anti-slip traction control system may be provided for automatically preventing excessive traction slip of any of the driving wheels of the vehicle. In such a case, the electronics is further arranged and programmed to coordinate the operation of the traction motor 17 and the operation of the engine 27 with the operation of said anti-slip traction control system for reducing the output of mechanical energy from the traction motor and from the engine respectively when the anti-slip traction control system is actuated, until the traction is restored. In fact, for safe operation, it will be preferable for a vehicle according to this invention to be equipped with an anti-slip traction control system and an anti-lock braking system.

It is well known in the art that a larger braking force of the front wheels of the vehicle is required for safe braking in a forward motion. Therefore, in embodiments of a hybrid electric vehicle according to this invention, for providing safe and efficient regenerative electric braking, it is preferable that the front wheels of the vehicle are its driving wheels.

The electric energy for the electric control circuits of the components of the above described driving and braking systems of the vehicle is supplied from a low-voltage electric power source via an appropriate switch, controllable by the operator of the vehicle. The low-voltage electric power source, which may be a 12V or 24V electric battery, and said switch, which may be the key master switch of the vehicle, are not shown for simplicity of drawing and description. Usually, the central electronic controller is actuated and the vehicle becomes operable when the operator of the vehicle turns on the master switch. In the following description of the program of the central electronic controllers and the operation of the vehicle, it is assumed that the central electronic controller is actuated and the vehicle is operable.

Hereinafter the program of the electronics 46 and the operation of the vehicle according to this invention is described:

(a) When the vehicle is not moving, which may be during the initiation of the operation of the vehicle or during a halt of the motion of the vehicle, the electronics detects no vehicle speed. The electronics is programmed, at the initiation of the operation of the vehicle, to instantly disengage the clutch 32, but not to start the internal-combustion engine 27 unless the electronics detects that the charge of the battery 38 is lower than a predetermined low level. The electronics is programmed, if it detects that the battery charge is lower than said predetermine low level, to start the engine 27 by momentarily operating the electric generator 34 as an electric motor powered by the electric battery 38, and then to operate the engine at a predetermined substantially constant rotational speed within the optimum fuel-efficiency speed range of the engine. The electronics is programmed to operate the generator as an electric motor powered by the battery only as long as it is necessary for starting the engine, and to switch back the machine to operate as an electric generator, immediately after the start of the engine. The electronics is programmed to stop the operation of the engine when a charge of the battery higher than said predetermined low level is detected. In the described operational state, the engine rests or drives the generator and the generator charges the battery;

(b) When the operator of the vehicle places the directional mode control switch 44 in the forward drive position and depresses the accelerator pedal 45, the electronics, being so programmed, will continue to keep the clutch 32 disengaged, will connect the traction motor 17 to the electric power source, and will operate the traction motor at continuously variable torque-speed output in response to the depression of the accelerator pedal 45. The mechanical energy transmitted from the traction motor to the driving wheels 12, 13 of the first axle will drive the vehicle in a forward/low-speed drive mode. The electronics is programmed, when the vehicle is moving forward, to keep the clutch disengaged and to drive the vehicle via the traction motor until a speed of the vehicle higher than said first predetermined speed is detected. When the speed of the vehicle is lower than the first predetermined speed, the electronics, being so programmed, will not start the internal-combustion engine, if the engine is not already running, unless it detects that the battery charge is lower than the predetermined low level, or the electric current drawn from the battery is stronger than a predetermined electric current, or the speed of the vehicle is between the first predetermined speed and a slightly lower second predetermined speed. The electronics is programmed, however, when it detects any one of the above conditions, to start and operate the engine at said predetermined substantially constant rotational speed within its optimum fuel-efficiency speed range, by the same manner as described above in (a). The electronics is programmed to monitor the magnitude of the electric current drawn from the battery and to start and operate the engine if that electric current is stronger than a predetermined electric current for preventing a very rapid discharge of the battery. The electronics is also programmed to stop the operation of the engine, if the engine is already running, when the battery charge is higher than the predetermined high level, the electric current drawn from the battery is weaker than said predetermined electric current, and the speed of the vehicle is lower than said second predetermined speed. This operational state continues from standstill to the first predetermined speed of the vehicle. At this operational state the vehicle operates as a series hybrid electric vehicle. The traction motor alone drives the vehicle in said forward/low-speed drive mode in response to the depression of the accelerator pedal, while the engine, operating at the predetermined substantially constant speed within its optimum fuel-efficiency speed range, drives the generator or rests. When the engine operates, the generator powers the traction motor 17, or charges the battery 38, or both. The electronics automatically varies at least the fuel and air intake of the engine, via the engine controller 41, for running the engine at the predetermined substantially constant speed under a continuously variable electrical load upon the electric generator. When the engine does not operate the battery powers the traction motor. How long, during the described forward/low-speed drive mode, the battery will be able to power the traction motor will depend mainly on the electric energy storage capacity of the battery, the state of charge of the battery before the start of the operation of the vehicle, and the load upon the traction motor. It is quite obvious for the skilled in the art that the power characteristics of the engine, traction motor, generator, and battery must be carefully selected during the design of the vehicle, depending on the specific kind and application of the vehicle and the required performance specifications. In this description it is assumed that the electronics is so programmed that the battery may be charged above said high level, until the battery is fully charged by the traction motor, when the traction motor operates as an electric braking generator, as it is described herein later. The specific low and high electric charge levels, between which the electric traction battery is sufficiently charged, depend on the specific kind and design of the battery and the operational voltage limits of the entire electric power plant. When the engine operates at said substantially constant rotational speed within its optimum fuel-efficiency speed range, the engine power output, as well as the generator power output, shall be capable of powering the dual-rotor motor and keeping the battery sufficiently charged under all normal driving conditions.

(c) When the vehicle moves forward and a speed of the vehicle higher than said first predetermined speed is detected, the electronics, being so programmed, will engage the clutch 32 and will operate the engine 27 at continuously variable torque-speed output in response to the depression of the accelerator pedal 45. The electronics is programmed to keep the battery connected to the generator controller if the battery charge is lower than the predetermined high level or to disconnect the battery from the generator controller if the battery charge is higher than the predetermined high level. The electronics is also programmed to disconnect the traction motor from the electric power source and to keep the traction motor disconnected from the electric power source, regardless of the depression of the accelerator pedal, when the internal-combustion engine alone is capable of sustaining the vehicle speed or of accelerating the vehicle to a higher speed in response to the depression of the accelerator pedal. Under these conditions, the internal-combustion engine drives the electric generator and the driving wheels of the first axle, while the traction motor is not energized and does not contribute to the propulsion of the vehicle. Therefore, the engine alone drives the vehicle in a forward/high-speed/normal-load drive mode. The electronics is also programmed to involve the traction motor in the propulsion of the vehicle when the engine alone is not capable of sustaining the vehicle speed or of accelerating the vehicle to a higher speed in response to the depression of the accelerator pedal. For this purpose, the electronics is programmed, if a charge of the battery higher than the predetermined low level is detected, to disconnect the generator from the battery and from the traction motor controller, to connect the traction motor to the battery, to gradually increase in a predetermined short period of time the electric power input to the traction motor from zero to an electric power input corresponding to the depression of the accelerator pedal, and then to operate the traction motor at continuously variable torque-speed output in response to the depression of the accelerator pedal. The gradual increase of the electric power input to the traction motor is programmed for avoiding an abrupt increase in the combined power output from the engine and traction motor. Under these conditions, the engine and the traction motor together drive the driving wheels of the first axle, driving the vehicle in a forward/high-speed/heavy load drive mode. Said predetermined short period of time when the electronics automatically gradually increases the power input to the traction motor, before starting to operate the traction motor in response to the depression of the accelerator pedal, depends mainly on the desired performance characteristic of the vehicle and is therefore a choice of the vehicle designer. The electronics is programmed to instantly involve the traction motor in the driving of the vehicle, as described above, when it detects that a predetermined very small increment of the depression of the accelerator pedal do not produce a substantially immediate predetermined acceleration (or reduction of deceleration) of the vehicle. When the desired vehicle speed is achieved and the operator of the vehicle decreases the depression of the accelerator pedal, the electronics, being so programmed, will disconnect the traction motor from the electric power source regardless of the depression of the accelerator pedal, will connect the generator to the battery and to the traction motor controller, and will continue to drive the vehicle only via the engine, as long as the engine alone is capable of sustaining the new vehicle speed or of accelerating the vehicle in response to the depression of the accelerator pedal. The described here forward/high-speed/heavy-load drive mode may last only until the battery is sufficiently charged. The electronics is programmed to return the operation of the vehicle in the above described forward/high-speed/normal-load drive mode when an electric charge of the battery lower than the predetermined low level is detected. This operational state continues from said first predetermined speed to the maximum speed of the vehicle. At this operational state the vehicle operates as a parallel hybrid electric vehicle. If the vehicle decelerates, while operating in one of the above described forward/high-speed drive modes, and a speed of the vehicle lower than the first predetermined speed is detected, the electronics, being so programmed, will return the operation of the vehicle in the described herein earlier in (b) forward/low-speed drive mode. The capability of the engine alone to drive the vehicle in the described high-speed/normal-load drive mode depends on the power of the engine and the load under which the vehicle is operating. Therefore, the engine shall have adequate power for driving the vehicle under normal load and driving conditions. For example, the engine shall be able to maintain a high cruising speed on a substantially level road in normal weather conditions. In this invention, the term “load” is used to indicate the sum of all forces resisting the motion of the vehicle;

(d) When the operator of the vehicle places the directional mode control switch in the backward drive position and depresses the accelerator pedal, the electronics, being so programmed, keeps the clutch disengaged and operates the traction motor and engine in the same manner as in said forward/low-speed drive mode, described herein above in (b). Here, however, the direction of rotation of the traction motor is reversed and the traction motor alone, operating at a continuously variable torque-speed output, drives the vehicle in a reverse drive mode. This operational state continues as long as the vehicle moves backward. At this operational state the vehicle operates as a series hybrid electric vehicle;

(e) The electronics is further programmed, when it detects that the vehicle accelerates when moving forward with a speed lower than the first predetermined speed and the accelerator pedal 45 is not depressed, to operate the traction motor as an electric braking generator for maintaining the speed of the vehicle substantially constant, while charging the electric battery with electric energy generated by the traction motor. Thus the electronics automatically provides vehicle speed retardation with recovery of energy when the vehicle moves downhill, and neither accelerator nor brake pedal is depressed. This operational state continues until the vehicle start to decelerate or the operator depresses the accelerator pedal or brake pedal for changing the speed of the vehicle;

(f) The electronics is also programmed, when it detects that the vehicle accelerates when moving forward with a speed higher than the first predetermined speed and the accelerator pedal is not depressed, to disengage the clutch, to operate the engine at the substantially constant speed within its optimum fuel-efficiency speed range, and to operate the traction motor as an electric braking generator for maintaining the speed of the vehicle substantially constant, while charging the electric battery with electric energy generated by the traction motor. Thus the electronics automatically provides vehicle speed retardation with recovery of energy when the vehicle moves downhill and neither accelerator nor brake pedal is depressed. This operational state continues until the vehicle start to decelerate or the operator depresses the accelerator pedal or brake pedal for changing the speed of the vehicle;

(g) The electronics is programmed, when it detects that the forward speed of the vehicle is lower than the first predetermined speed and the brake pedal 52 is depressed, to operate the traction motor as an electric braking generator for braking the vehicle and charging the battery. The electronics is programmed to brake the vehicle only via the traction motor when in response to the depression of the brake pedal the traction motor alone provides a continuously variable braking force capable of sustaining the vehicle speed during speed retardation or of decelerating the vehicle to a lower desirable speed during braking. The electronics is also programmed to involve said wheel brakes 47, 48, 49, 50, via said wheel brakes actuator 51, in the braking of the vehicle when it detects that the traction motor alone, in response to the depression of the brake pedal, does not provide a continuously variable braking force capable of sustaining the vehicle speed during speed retardation or of decelerating the vehicle to a lower desirable speed during braking, while charging the electric battery. For this purpose, and for avoiding an abrupt increase in the combined braking force of the traction motor and wheel brakes, the electronics is programmed to gradually apply the wheel brakes increasing in a predetermined very short period of time their braking force from zero to a braking force corresponding to the depression of the brake pedal, and then to control the continuously variable braking force of the wheel brakes in response to the depression of the brake pedal. Said predetermined very short period of time when the electronics automatically gradually increases the braking force of the wheel brakes and the specific character of that gradual increase of the braking force depends on the specific arrangement of the wheel brakes actuator and the desired performance characteristic of the vehicle, and is therefore a choice of the vehicle designer. The electronics is programmed to instantly involve the wheel brakes in the braking of the vehicle, as it is described above, if it detects that a predetermined very small increment of the depression of the brake pedal does not produce a substantially immediate predetermined deceleration of the vehicle. When the desired vehicle speed is achieved and the operator of the vehicle decreases the depression of the brake pedal, the electronics, being so programmed, will discontinue the braking action of the wheel brakes and will continue to brake the vehicle only via the traction motor, as long as the traction motor alone is capable of sustaining the new vehicle speed or of decelerating the vehicle to a lower desirable speed in response to the depression of the brake pedal;

(h) The electronics is programmed, when it detects that the forward speed of the vehicle is higher than the first predetermined speed and the brake pedal 52 is depressed, to disengage the clutch, to operate the internal-combustion engine at the predetermined substantially constant rotational speed within its optimum fuel-efficiency speed range, and to operate the traction motor as an electric braking generator and the wheel brakes in the same manner as is described herein above in (g);

(i) The electronics is programmed to discontinue the operation of the traction motor as an electric braking generator regardless of the depression of the brake pedal and to brake the vehicle with the wheel brakes via the wheel brakes actuator in response to the depression of the brake pedal, when differences between the rotational speeds of the wheels of the vehicle larger than respective predetermined differences are detected, wherein said predetermined speed differences vary with the variation of the steering angle of the steering wheel 53 of the vehicle. Otherwise said, the electronics is programmed to discontinue the braking of the vehicle via the traction motor, regardless of the depression of the braking pedal, and to brake the vehicle only via the wheel brakes in response to the depression of the brake pedal when a pending lockup of any of the wheels of the vehicle is detected;

(j) The electronics is programmed to brake the vehicle with the wheel brakes via the wheel brakes actuator in response to the depression of the brake pedal when the electric battery is fully charged; and

(k) The electronics is programmed, when it detects that the vehicle is not moving or is moving backward, to apply the wheel brakes via the wheel brakes actuator in response to the depression of the brake pedal, and thus to prevent unintentional motion of the vehicle or to brake the vehicle during a backward motion respectively.

It is evident from the described above program of the electronics and the operation of the vehicle that the internal-combustion engine in a vehicle according to this invention starts when is not involved mechanically in the propulsion of the vehicle, never idle, and never operates at rotational speeds lover than a predetermined rotational speed within its optimum fuel-efficiency speed range. This arrangement provides for an easy start and high fuel efficiency of the engine, which are other major advantages of this invention over most of the known parallel hybrid electric vehicles.

Said first predetermined speed of the vehicle is selected to be the speed that the vehicle would have if the internal-combustion engine operating at a speed equal to said predetermined substantially constant rotational speed within its optimum fuel-efficiency speed range drives the driving wheels of the first axle through the second mechanical drive train. Said second predetermined speed of the vehicle is slightly lower than the first predetermined speed so that, if the engine is started during acceleration of the vehicle at that second predetermined speed, the engine would have enough time to accelerate up to the predetermine substantially constant rotational speed before the vehicle have reached its first predetermined speed. At such operational program, the engine operates at the predetermined substantially constant speed within its optimum fuel-efficiency speed range during any change from forward/low-speed drive mode to any of the two forward/high-speed drive modes and vice versa. Such an arrangement provides for a perfectly smooth frictionless operation of the clutch, because the two components of the second drive train which the clutch engages or disengages during any change of the drive mode rotate with the same speeds.

If the optimum fuel-efficiency speed range of the engine is relatively narrow, then said predetermined substantially constant rotational speed at which the engine operates during the low-speed drive mode is predetermined by the vehicle designer and recorded in the program of the electronics. If the optimum fuel efficiency speed range of the engine is relatively wide, then the electronics may be arranged and programmed to enable the operator of the vehicle to pre-select a lower or a higher substantially constant rotational speed of the engine, within its optimum fuel-efficiency speed range, depending on the current operational conditions of the vehicle. In such a case, the electronics is arranged and programmed at any change of the predetermined substantially constant rotational speed of the engine to automatically change accordingly the first and second predetermined speeds of the vehicle, so that the relationship between these three speeds remain as described above. The operator of the vehicle pre-selects a specific substantially constant rotational speed of the engine within its optimum fuel-efficiency speed range via an appropriate switch or other device connected with the electronics 46, which device and connection are not shown for simplicity of drawing and description.

In some embodiment the electric generator 34 may be further arranged to selectively operate as an additional electric traction motor, and the generator controller 40 may be further arranged to selectively operate the generator as an additional electric traction motor powered by the battery 38. In such an arrangement, the electronics 46 is further programmed to operate the generator as an additional electric traction motor when a speed of the vehicle higher than the first predetermined speed is detected and the accelerator pedal 45 is fully depressed by the operator of the vehicle. In this invention, the expression “fully depressed” means that the accelerator pedal is depressed beyond a predetermined for normal operation of the vehicle maximum depression. Under such conditions, the electronics also operates the traction motor at its maximum torque-speed output and the internal-combustion engine at its richest fuel supply. Such an arrangement allows the combined power output of the engine, traction motor, and electric generator to be used for driving the vehicle in a high-speed/extreme-power drive mode when a very high power is demanded due to some exceptional road circumstances (for example, during a dangerous passing). In this operational mode, the battery supplies both the generator and the traction motor with electric power and the electrical current drawn from the battery is relatively very strong. Therefore, the electronics is also programmed to automatically terminate the operation of the generator as an additional traction motor, when it is necessary for protecting the electric battery from overheating.

In this description the expressions “in response to the depression of the accelerator pedal” means that the control signals from the central electronic controller to the traction motor controller or to the engine controller respectively are functions of the control signals from the depression of the accelerator pedal. In this description the expression “in response to the depression of the brake pedal” means that the control signals from the central electronic controller to the traction motor controller (when the traction motor operates as an electric braking generator) and to the wheel brakes actuator respectively are functions of the control signals from the depression of the brake pedal. The described above arrangement and program of the electronics provide immediate, direct, and linier control of the continuously variable tractive and braking forces respectively via the accelerator and brake pedals of the vehicle. This is one of the major advantages of this invention in comparison to the prior art.

In some embodiments, the vehicle according to this invention is further equipped with a cruise control system for automatically maintaining a substantially constant cruising speed of the vehicle. In such a case, the electronics 46 is further programmed, when the cruise control system is turned on and the cruising speed is set up by the operator of the vehicle, to automatically operate the engine and the traction motor respectively for maintaining the selected cruising speed of the vehicle substantially constant if the accelerator pedal and brake pedal are not depressed by the operator of the vehicle. The electronics is also programmed to return to the normal control of the tractive force by the acceleration pedal when the accelerator pedal is depressed by the operator of the vehicle, and to the normal control of the braking force by the brake pedal when the brake pedal is depressed by the operator of the vehicle, wherein at the depression of the accelerator pedal the cruise control setup is not canceled, and at the depression of the brake pedal the cruise control setup is canceled. For simplicity of drawing and description, however, the control switches by which the operator of the vehicle manually turns on or off the cruise control and sets or resets the cruising speed, and the relationship of said control switches with the electronics are not shown. No other details of the cruise control system are shown or claimed.

In some embodiments, the clutch actuator 39 may be further arranged to automatically engage the clutch 32 when the vehicle is parked and the master switch of the vehicle is turned off, i.e. when the electronics does not control the clutch actuator. If the clutch is engaged when the vehicle is parked, the internal combustion engine provides a motion resisting force, which improves the safety against an unintentional motion of the vehicle. The specific arrangement of the engagement of the clutch, when the vehicle is parked, depends on the specific type of the clutch and the method of its operation, and therefore is not described or claimed.

Referring in sequence from FIG. 2 to FIG. 4, only what is different in comparison with the embodiment of the vehicle of FIG. 1 is hereinafter briefly described.

Referring to FIG. 2, the traction motor 17 is attached to the transaxle enclosure 37 on the opposite side of the attachment of the engine 27 to the transaxle enclosures. This location of the traction motor is the only difference with the first embodiment. In this second embodiment, all components and the operation of the vehicle are the same as described with FIG. 1.

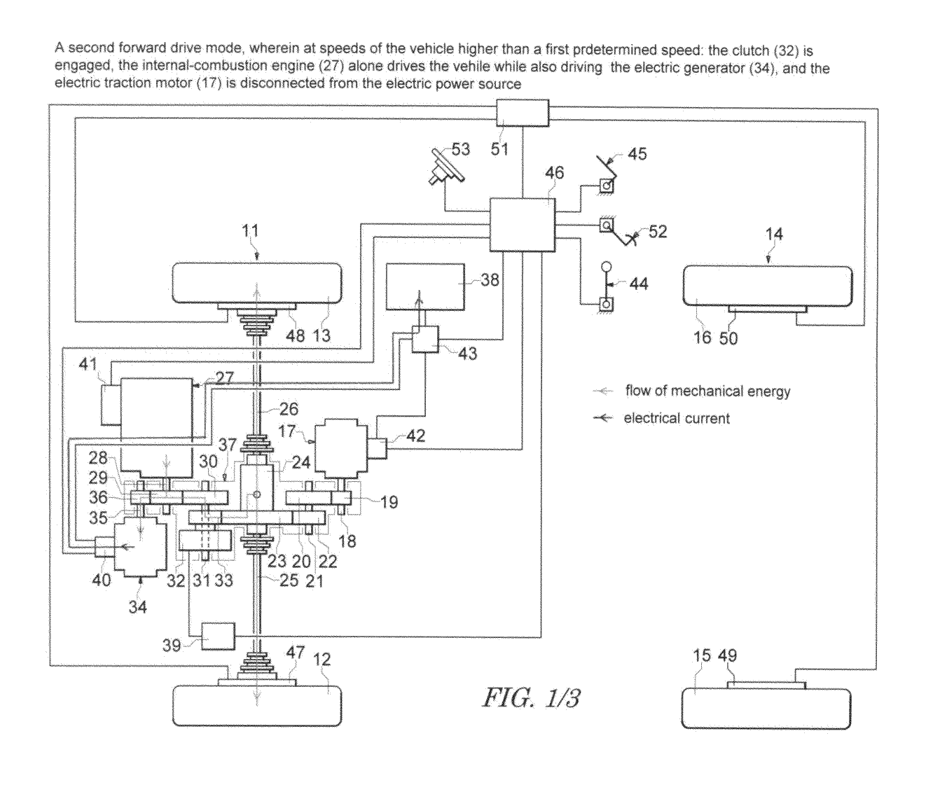

Referring to FIG. 3, the engine 27 is located above the first axle 11 in a longitudinal configuration. The traction motor 17 and electric generator 37 are in parallel to the engine.

In this third embodiment, the first mechanical drive train includes a planetary-gear type speed reducer 54. Hereinafter, for abbreviation of this description, the shorter term “planetary gear reducer” is used instead of the term “planetary-gear type speed reducer”. A sun gear 55 of the planetary gear reducer 54 is coupled with the output shaft 18 of the traction motor and is engaged with the planet gears 56 of the planetary gear reducer. A carrier 57 of the planet gears 56 is immobile. The planet gears are engaged with a ring gear 58 of the planetary gear reducer. The ring gear 58 is coupled with a clutch shaft 59. A bevel pinion gear 60 is coupled or integrated with the clutch shaft 59 and is engaged with a bevel crown gear 61 coupled with a differential 24 of the first axle 11. In this embodiment, it is assumed that the driving wheels 12, 13 are independently suspended to the frame of the vehicle and the mechanical energy is transmitted from the differential to the driving wheels as described with FIG. 1. In this embodiment, the beveled pinion and crown gears (which are typically called “final drive”) and the differential are enclosed and rotatably supported within a first axle enclosure 62.

In this third embodiment, in the second mechanical drive train the gear 29 coupled with the output shaft 28 of the engine is engaged with an intermediate gear 63 mounted onto an intermediate shaft 64. Said intermediate gear 63 is also engaged with the clutch gear 33 of the clutch 32, which is mounted on the clutch shaft 59. In this embodiment, it is assumed that when the clutch is engaged the clutch gear 33 is coupled with clutch shaft 59, and when the clutch is disengaged the clutch gear is not coupled with the clutch shaft and may rotate freely upon the clutch shaft. Thus, when the clutch is engaged mechanical energy is transmitted between the engine and the driving wheels of the first axle, and when the clutch is disengaged this transmission is interrupted.

In this third embodiment, in the third mechanical drive train the input shaft 35 of the electric generator 34 is coupled directly with the output shaft 28 of the engine 27 by a coupling 65. Such arrangement is appropriate when the efficient operational speed range of the engine is similar to the efficient operational speed range of the generator.

In this third embodiment, all component of the first, second, and third drive trains, with the exception of those enclosed within said first axle enclosure 62 (as it is herein above described), are enclosed and rotatably supported within a transmission enclosure 66. Although gabs between said transmission enclosure 66 and the traction motor 17, engine 27, and generator 34 are shown for clarity, it is assumed that these three power components, as well as the first axle enclosure 62, are firmly attached to the transmission enclosure. The entire block composed of these firmly attached components is firmly attached to the frame of the vehicle.

In this third embodiment, all other components and the operation of the vehicle are the same as described with FIG. 1.

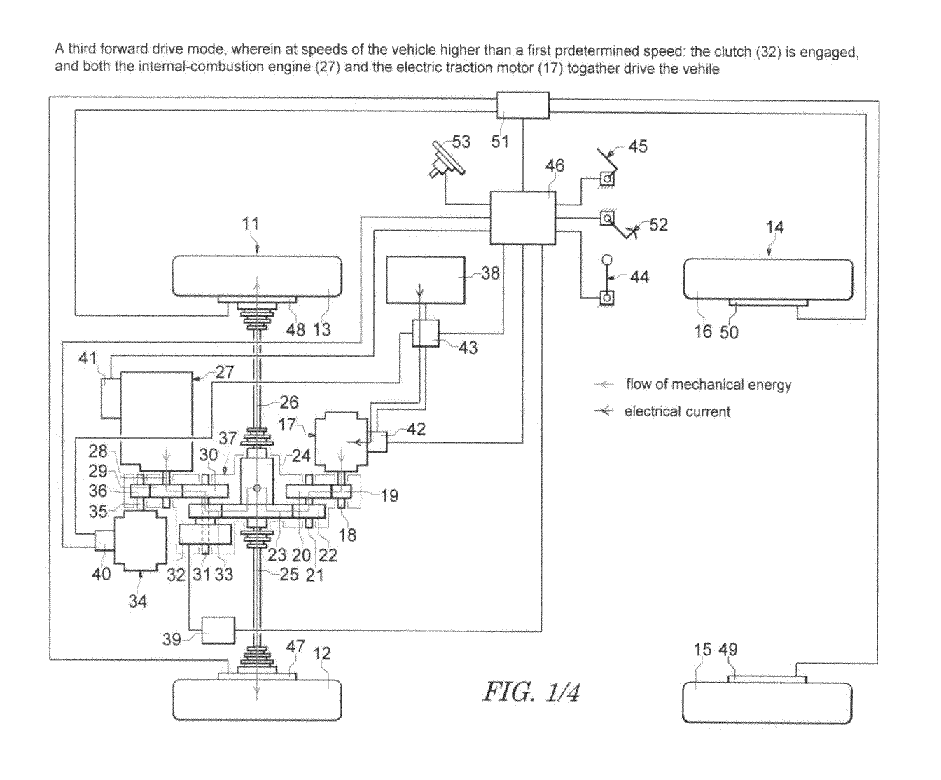

Referring to FIG. 4, the entire block composed of the engine 27, traction motor 17, generator 34, and transmission enclosure 66 is in a longitudinal configuration, similar to that shown with FIG. 3, but on some distance from the first axle 11.

In this fourth embodiment, the first mechanical drive train include said planetary gear reducer 54, as it is described with FIG. 3. Here, the clutch shaft 59 extends from the transmission enclosure 66 towards the first axle 11. A cardan shaft 67 connects the clutch shaft with an input shaft 68 of the first axle, which input shaft is coupled or integrated with said pinion gear 60. The cardan shaft 67 is actually an assembly of a shaft and two cardan joints. Such an embodiment, wherein the transmission of mechanical energy includes a cardan shaft, may be beneficial if bigger ground clearance under the traction motor is required.

In this fourth embodiment, the second mechanical drive train includes a sprocket wheel 69 coupled with the output shaft 28 of the engine 27, a clutch sprocket wheel 70 of the clutch 32, and a chain 71 engaged with said two sprocket wheels 69, 70 for transmitting mechanical energy between the engine and the clutch shaft 59. The function of the clutch 32 remains the same as described with FIG. 1. When the clutch is engaged it couples the clutch sprocket wheel 70 with the clutch shaft 59, and when the clutch is disengaged the clutch sprocket wheel is not coupled with the clutch shaft and may rotate freely upon the clutch shaft.

In this fourth embodiment, the third mechanical drive train is as described with FIG. 3.

In this fourth embodiment, all other components and the operation of the vehicle are the same as described with FIG. 1.

From the above detail descriptions it is clear that in the embodiments illustrated by the drawings in FIG. 1 to FIG. 4 only the locations of some of the major components and the specific arrangements of said three mechanical drive trains of the vehicle are more or less different. The method of operating the components of the power train and the method of driving and braking the vehicle are the same in each of these embodiments. Actually, these several embodiments of a vehicle according to this invention are shown and described mainly for illustrating that many different locations of the engine, traction motor, and electric generator, and specific arrangements of the three mechanical drive trains are possible. It is quite obvious for the skilled in the art that a number of other combinations may also be derived from the already described embodiments, as well as that many other embodiments of a vehicle according to this invention are possible. For example, the electric generator may be sandwiched between the engine and transmission enclosure and the input shaft of the generator coupled directly or integrated with the output shaft of the engine. In such an embodiment, the integrated shaft of engine and electric generator is the only component of the third drive train. Or the generator may by attached to the transaxle enclosure on the engine side and connected to the engine via an appropriate third mechanical drive train. Or a two-stage planetary gear reducer may be included in the first drive train instead of the described single-stage planetary gear reducer, if a greater speed-reduction ratio is required, etc. Any such other locations of the major components or specific arrangements of each of the three mechanical drive trains will represent just other embodiments of the vehicle according to this invention.

It is also obvious that the speed-reduction ratios of any one of the three mechanical drive trains may be selected in accordance with the specific characteristics and limitations of the engine, traction motor, and generator, desired performance characteristics of the drive and braking systems, and other design considerations. Therefore the rotational speed reducers included respectively in the drive trains may differ from the described above speed reducers. All different arrangements of the speed reducers included in the mechanical drive trains will represent just other embodiments of the vehicle according to this invention. What is relevant for this invention is that each of the three mechanical drive trains provides one (single) rotational speed-reduction ratio. These drive trains are very simple and efficient.

It is also evident that each of the components of a vehicle according to this invention may be of a different specific kind, type, and design, appropriate to perform the functions according to this invention. For example, the internal-combustion engine may be a reciprocating-piston gas or diesel engine, or another type of internal-combustion engine, the electric generator and the traction motor each may be a direct-current or an alternating-current electrical machine, etc. The incorporation of components of different specific kinds or types will simply produce different specific embodiments of a vehicle according to this invention.

1. A vehicle comprising:
a first axle including two driving wheels and a second axle including two free-rolling wheels, wherein said two wheels of at least one of said two axles are also steerable for steering the vehicle;
an electric traction motor for selectively driving said two driving wheels of said first axle when said electric traction motor is energized, wherein the direction of rotation of the electric traction motor is reversible;
a first mechanical drive train connecting the electric traction motor with the driving wheels of the first axle for transmitting mechanical energy between the traction motor and the driving wheels of the first axle;
an electric power source for supplying the electric traction motor with electric energy, said electric power source including an electric battery for storing electric energy and selectively supplying the electric traction motor with electric energy and an electric generator for charging said electric battery and selectively supplying the electric traction motor with electric energy;
an internal-combustion engine for selectively driving said electric generator or the driving wheels of the first axle and the electric generator;
a second mechanical drive train connecting said internal-combustion engine with the driving wheels of the first axle for transmitting mechanical energy between the internal-combustion engine and the driving wheels of the first axle, said second mechanical drive train including a part of said first mechanical drive train;
a clutch included in the second mechanical drive train for selectively interrupting the transmission of mechanical energy between the internal-combustion engine and the driving wheels of the first axle;
a third mechanical drive train connecting the internal-combustion engine with the electric generator for transmitting mechanical energy between the internal-combustion engine and the electric generator, said third mechanical drive train including a part of the second mechanical drive train; and
a central electronic controller arranged and programmed to control and coordinate the operation of the electric traction motor, internal-combustion engine, electric generator, and said clutch, for operating the vehicle and charging the electric battery.

2. A vehicle according to claim 1, wherein said central electronic controller is arranged and programmed to operate the vehicle in the following drive modes:
a first forward drive mode, wherein at speeds of the vehicle lower than a first predetermined speed said clutch is disengaged, said electric traction motor alone drives the vehicle, and said internal-combustion engine drives said electric generator or rests;
a second forward drive mode, wherein at speeds of the vehicle higher than said first predetermined speed the clutch is engaged, the internal-combustion engine alone drives the vehicle while also driving the electric generator, and the electric traction motor is disconnected from said electric power source;
a third forward drive mode, wherein at speeds of the vehicle higher than the first predetermined speed the clutch is engaged and both the internal-combustion engine and the electric traction motor together drive the vehicle; and
a reverse drive mode, wherein the clutch is disengaged, said direction of rotation of the electric traction motor is reversed, the traction motor alone drives the vehicle backward, and the internal-combustion engine drives the electric generator or rests.

3. A vehicle according to claim 1, wherein said electric generator is further arranged to selectively operate as an electric motor powered by said electric battery for starting said internal-combustion engine.

4. A vehicle according to claim 1, and further comprising:
a clutch actuator for engaging or disengaging said clutch, wherein said clutch actuator is electrically controllable;
an electric generator controller for automatically controlling the operation of said electric generator and further arranged for selectively operating the electric generator as an electric motor, wherein the operation of the electric generator as an electric motor is electrically controllable;
an internal-combustion engine controller for operating said internal-combustion engine, wherein said internal-combustion engine controller is electrically controllable;
an electric traction motor controller for operating said electric traction motor, wherein said electric traction motor controller is electrically controllable;
an electric battery charger electrically connecting the electric generator controller, electric battery, and electric traction motor controller to each other respectively, and arranged for selectively disconnecting the electric generator controller, electric battery, and electric traction motor controller from each other respectively, wherein said electric battery charger is electrically controllable;
a directional mode control switch controllable by the operator of the vehicle for pre-selecting a forward drive mode, preparing the electric traction motor for driving the vehicle forward, or a reverse drive mode, preparing the electric traction motor for driving the vehicle backward, or a neutral drive mode disconnecting the electric traction motor from said electric power source; and
an accelerator pedal controllable by the operator of the vehicle for providing continuously variable control of the tractive force of the vehicle by varying the depression of said accelerator pedal.

5. A vehicle according to claim 4, wherein said clutch actuator is further arranged to engage said clutch when the vehicle is parked.

6. A vehicle according to claim 4, wherein said electric battery charger is further arranged for selectively charging said electric battery from an external source of electric energy when the vehicle is parked and the electric battery charger is electrically connected to said external source of electric energy.

7. A vehicle according to claim 4, wherein said central electronic controller is arranged to continuously monitor the position of said directional mode control switch, the depression of said accelerator pedal, the speed and acceleration of the vehicle, the rotational output speed of said internal-combustion engine, the state of charge of said electric battery, and the magnitude of the electric current drawn from the electric battery, and wherein the central electronic controller is also arranged to control the operation of said clutch, electric generator, electric traction motor, internal-combustion engine, and the charging of said electric battery, via said clutch actuator, electric generator controller, electric traction motor controller, internal-combustion engine controller, and electric battery charger respectively, and wherein the central electronic controller is programmed:
(a) to disengage said clutch and to keep the clutch disengaged when the vehicle is not moving, when the vehicle is moving forward with speeds lower than said first predetermined speed, and when the vehicle is moving backward;
(b) to start said internal-combustion engine, if the internal-combustion engine is not already running, and to operate the internal-combustion engine at a predetermined substantially constant rotational speed within the optimum fuel-efficiency speed range of the internal-combustion engine when the vehicle is not moving, when the vehicle is moving forward with speeds lover than said first predetermined speed, and when the vehicle is moving backward only if any of the following conditions are detected: (i) the charge of said electric battery is lower than a predetermined low level, (ii) the electric current drawn from the electric battery is stronger than a predetermined electric current, and (iii) the speed of the vehicle is between the first predetermined speed and a slightly lower second predetermined speed;
(c) to stop the operation of the internal-combustion engine, if the internal-combustion engine is already running, when the vehicle is not moving, when the vehicle is moving forward with speeds lower than said second predetermined speed, and when the vehicle is moving backward, if the charge of the electric battery is higher than said predetermined low level and the electric current drawn from the electric battery is weaker than said predetermined electric current;
(d) to operate said electric traction motor at continuously variable torque-speed output in response to the depression of said accelerator pedal when the vehicle is moving forward at speeds lower than the first predetermined speed and when the vehicle is moving backward;
(e) to engage the clutch and to keep the clutch engaged when the vehicle is moving forward with speeds higher than the first predetermined speed;
(f) to operate the internal-combustion engine at continuously variable torque-speed output in response to the depression of the accelerator pedal when the vehicle is moving forward with speeds higher than the first predetermined speed;
(g) to disconnect the electric traction motor from the electric power source regardless of the depression of the accelerator pedal when the vehicle is moving forward with speeds higher than the first predetermined speed and the internal-combustion engine alone is capable of sustaining the vehicle speed or of accelerating the vehicle to a higher speed in response to the depression of the accelerator pedal;
(h) to disconnect the electric generator from the electric battery and from the electric traction motor, to connect the electric traction motor to the electric battery, and to operate the electric traction motor at continuously variable torque-speed output in response to the depression of the accelerator pedal when the vehicle is moving forward at speeds higher than the first predetermined speed, the internal-combustion engine alone is not capable of sustaining the vehicle speed or of accelerating the vehicle to a higher speed in response to the depression of the accelerator pedal, and the charge of the electric battery is higher than the predetermined low level; and
(i) to disconnect the electric battery from the electric generator when the internal-combustion engine operates and the charge of the electric battery is higher than said predetermined high level.

8. A vehicle according to claim 7, wherein said first predetermined speed of the vehicle is the speed with which the vehicle moves when said clutch is engaged and said internal-combustion engine, operating at said predetermined substantially constant rotational speed within its optimum fuel-efficiency speed range, drives the driving wheels of said first axle.

9. A vehicle according to claim 7, wherein said electric generator is further arranged to selectively operate as an additional electric traction motor powered by said electric battery, and said central electronic controller is further programmed to operate the electric generator as an additional electric traction motor via said electric generator controller when the vehicle moves forward with a speeds higher than said first predetermined speed and said accelerator pedal is fully depressed.

10. A vehicle according to claim 7, wherein said electric traction motor is further arranged to selectively operate as an electric braking generator powered by the kinetic energy of the vehicle, and said traction motor controller is further arranged to selectively operate the traction motor as an electric braking generator for converting part of the kinetic energy of the vehicle into electric energy charging said electric battery during vehicle speed retardation or during braking of the vehicle, wherein the operation of the electric traction motor as an electric braking generator is electrically controllable, and wherein the vehicle further comprising:
wheel brakes for braking the rotation of said wheels of said axles;
an electrically controllable wheel brakes actuator for selectively applying said wheel brakes;
a brake pedal controllable by the operator of the vehicle for providing continuously variable control of the braking force of the vehicle by varying the depression of said brake pedal; and
a steering wheel controllable by the operator of the vehicle for varying the steering angle of said steerable wheels.

11. A vehicle according to claim 10 wherein said central electronic controller is further arranged to continuously monitor the depression of said brake pedal, the steering angle of said steering wheel, and the rotational speeds of said wheels of said axles, and to control the operation of said electric traction motor as an electric braking generator and the operation of said wheel brakes actuator, and wherein the central electronics controller is further programmed:
(a) to operate the electric traction motor as an electric braking generator for maintaining the speed of the vehicle substantially constant and charging the electric battery when the vehicle is moving forward at a speed lower than said first predetermined speed, said accelerator pedal is not depressed, and an acceleration of the vehicle is detected;
(b) to disengage the clutch, to operate said internal-combustion engine at said substantially constant speed within its optimum fuel-efficiency speed range, and to operate the electric traction motor as an electric braking generator for maintaining the speed of the vehicle substantially constant and charging the electric battery when the vehicle is moving forward at a speed higher than the first predetermined speed, the accelerator pedal is not depressed, and an acceleration of the vehicle is detected;
(c) When the vehicle is moving forward with a speed lower than the first predetermined speed and said brake pedal is depressed:
(i) to operate the electric traction motor as an electric braking generator when in response to the depression of the brake pedal the electric traction motor alone while charging the electric battery provides a continuously variable braking force capable of sustaining the vehicle speed during speed retardation or of decelerating the vehicle to a lower desirable speed during braking;
(ii) to operate the electric traction motor as an electric braking generator and, when in response to the depression of the brake pedal the electric traction motor alone does not provide a continuously variable braking force capable of sustaining the vehicle speed during speed retardation or of decelerating the vehicle to a lower desirable speed during braking, to apply said wheel brakes, and then to control the continuously variable braking force of the traction motor and wheel brakes in response to the depression of the brake pedal;
(iii) to discontinue the operation of the electric traction motor as an electric braking generator regardless of the depression of the brake pedal and to brake the vehicle only via the wheel brakes in response to the depression of the brake pedal when a pending lockup of any of said driving wheels is detected; and
(iv) to brake the vehicle only via the wheel brakes in response to the depression of the brake pedal when the electric battery is fully charged;
(d) When the vehicle is moving forward with a speed higher than the first predetermined speed and the brake pedal is depressed to disengage the clutch, to operate the internal-combustion engine at the predetermined substantially constant speed within its optimum fuel-efficiency speed range, and:
(i) to operate the electric traction motor as an electric braking generator when in response to the depression of the brake pedal the electric traction motor alone while charging the electric battery provides a braking force capable of sustaining the vehicle speed during speed retardation or of decelerating the vehicle to a lower desirable speed during braking;
(ii) to operate the electric traction motor as an electric braking generator and, when in response to the depression of the brake pedal the electric traction motor alone does not provide a continuously variable braking force capable of sustaining the vehicle speed during speed retardation or of decelerating the vehicle to a lower desirable speed during braking, to apply the wheel brakes, and then to control the continuously variable braking force of the traction motor and wheel brakes in response to the depression of the brake pedal;
(iii) to discontinue the operation of the electric traction motor as an electric braking generator regardless of the depression of the brake pedal and to brake the vehicle only via the wheel brakes in response to the depression of the brake pedal when a pending lockup of any of said driving wheels is detected; and
(iv) to brake the vehicle only via the wheel brakes when the electric battery is fully charged; and
(e) when the vehicle is not moving or is moving backward, to apply the wheel brakes in response to the depression of the brake pedal.

12. A vehicle according to claim 11, and further comprising a cruise control system for automatically maintaining a substantially constant cruising speed of the vehicle, wherein said central electronic controller is further programmed, when said cruise control system is turned on and said cruising speed of the vehicle is set up by the operator of the vehicle, to automatically operate said internal-combustion engine and said electric traction motor respectively for maintaining the substantially constant cruising speed of the vehicle if said accelerator pedal and said brake pedal are not depressed by the operator of the vehicle, and to return to the control of the tractive force via the accelerator pedal when the accelerator pedal is depressed by the operator of the vehicle, and to return to the control of the braking force via the brake pedal when the brake pedal is depressed by the operator of the vehicle.

13. A method for operating a vehicle comprising a first axle including two driving wheels and a second axle including two free-rolling wheels, wherein said wheels of at least one of said two axles are also steerable for steering the vehicle, said method for operating the vehicle comprising the steps of:
driving the vehicle forward from standstill to a first predetermined speed of the vehicle via an electric traction motor in a forward/low-speed drive mode;
driving the vehicle forward at speeds of the vehicle higher than said first predetermined speed under normal load via an internal-combustion engine in a forward/high-speed/normal-load drive mode;
driving the vehicle forward at speeds of the vehicle higher than the first predetermined speed under heavy load via both said internal-combustion engine and said electric traction motor in a forward/high-speed/heavy-load drive mode when the internal-combustion engine alone is not capable to sustain the vehicle speed or to accelerate the vehicle to a higher desirable speed; and
driving the vehicle backward in a reverse drive mode via the electric traction motor, wherein the direction of rotation of the electric traction motor is reversed.

14. A method for operating a vehicle according to claim 13, and further comprising the steps of:
transmitting mechanical energy between said electric traction motor and said driving wheels of said first axle via a first mechanical drive train;
transmitting mechanical energy between said internal-combustion engine and the driving wheels of the first axle via a second mechanical drive train including a part of said first mechanical drive train;
selectively interrupting the transmission of mechanical energy between the internal-combustion engine and the driving wheels of the first axle via a clutch included in said second mechanical drive train;
supplying the electric traction motor with electric energy from an electric power source including an electric battery for storing electric energy and selectively supplying the electric traction motor with electric energy, and an electric generator for charging said electric battery and selectively supplying the electric traction motor with electric energy, wherein the internal-combustion engine drives said electric generator; and
transmitting mechanical energy between the internal-combustion engine and said electric generator via a third mechanical drive train including a part of said second mechanical drive train.

15. A method for operating a vehicle according to claim 13, and further comprising the step of selectively operating said electric generator as an electric motor powered by said electric battery for starting said internal-combustion engine, wherein the operation of the electric generator as an electric motor is electrically controllable.

16. A method for operating a vehicle according to claim 13, and further comprising the step of controlling and coordinating the operation of said clutch, said electric traction motor, said internal-combustion engine, and said electric generator via a central electronic controller for driving the vehicle in said different drive modes and charging said electric battery, wherein said central electronic controller is arranged and programmed:
(a) to disengage the clutch and to keep the clutch disengaged when the vehicle is not moving, when the vehicle is moving forward with speeds lower than said first predetermined speed, and when the vehicle is moving backward;
(b) to start the internal-combustion engine, if the internal-combustion engine is not already running, and to operate the internal-combustion engine at a predetermined substantially constant rotational speed within the optimum fuel-efficiency speed range of the internal-combustion engine when the vehicle is not moving, when the vehicle is moving forward with speeds lover than said first predetermined speed, and when the vehicle is moving backward only if any of the following conditions are detected: (i) the charge of said electric battery is lower than a predetermined low level, (ii) the electric current drawn from the electric battery is stronger than a predetermined electric current, and (iii) the speed of the vehicle is between the first predetermined speed and a slightly lower second predetermined speed;
(c) to stop the operation of the internal-combustion engine, if the internal-combustion engine is already running, when the vehicle is not moving, when the vehicle is moving forward with speeds lower than said second predetermined speed, and when the vehicle is moving backward, if the charge of the electric battery is higher than said predetermined low level and the electric current drawn from the electric battery is weaker than said predetermined electric current;
(d) to operate the electric traction motor at continuously variable torque-speed output in response to the depression of an accelerator pedal controllable by the operator of the vehicle when the vehicle is moving forward at speeds lower than the first predetermined speed and when the vehicle is moving backward;
(e) to engage the clutch and to keep the clutch engaged when the vehicle is moving forward with speeds higher than the first predetermined speed;
(f) to operate the internal-combustion engine at continuously variable torque-speed output in response to the depression of said accelerator pedal when the vehicle is moving forward with speeds higher than the first predetermined speed;
(g) to disconnect the electric traction motor from the electric power source regardless of the depression of the accelerator pedal when the vehicle is moving forward with speeds higher than the first predetermined speed and the internal-combustion engine alone is capable of sustaining the vehicle speed or of accelerating the vehicle to a higher speed in response to the depression of the accelerator pedal;
(h) to disconnect the electric generator from the electric battery and from the electric traction motor, to connect the electric traction motor to the electric battery, and to operate the electric traction motor at continuously variable torque-speed output in response to the depression of the accelerator pedal when the vehicle is moving forward at speeds higher than the first predetermined speed, the internal-combustion engine alone is not capable of sustaining the vehicle speed or of accelerating the vehicle to a higher speed in response to the depression of the accelerator pedal, and the charge of the electric battery is higher than the predetermined low level; and
(i) to disconnect the electric battery from the electric generator when the internal-combustion engine operates and the charge of the electric battery is higher than a predetermined high level.

17. A method for operating a vehicle according to claim 13, and further comprising the steps of:
selectively operating said electric generator as an additional electric traction motor powered by said electric battery for driving said driving wheels of said first axle, via said third and second drive trains, when the vehicle is moving whit speeds higher than the first predetermined speed and said accelerator pedal is fully depressed, and controlling the operation of the electric generator as an additional electric traction motor via said central electronic controller, wherein the central electronic controller is further programmed to automatically terminate the operation of electric generator as an additional electric traction motor if it is necessary for protecting the electric battery from overheating.

18. A method for operating a vehicle according to claim 13, and further comprising the steps of:
selectively operating said electric traction motor as an electric braking generator driven by the kinetic energy of the vehicle during speed retardation or braking of the vehicle for charging said electric battery, and
controlling said selective operation of the electric traction motor as an electric braking generator via said central electronic controller.

19. A method for operating a vehicle according to claim 16, wherein said first predetermined speed of the vehicle is the speed, which the vehicle would have if said clutch is engaged and said internal-combustion engine operating at said predetermined substantially constant rotational speed within the optimum fuel-efficiency speed range of the internal-combustion engine drives the driving wheels of said first axle.

20. A method for operating a vehicle according to claim 18, and further comprising the steps of:
Controlling the continuously variable braking force of the vehicle by the depression of a brake pedal controllable by the operator of the vehicle, wherein said central electronic controllers is further arranged to continuously monitor the depression of said brake pedal, the steering angle of a steering wheel, and the rotational speeds of said wheels of said axles, and to control the operation of said electric traction motor as an electric braking generator and the operation of said vehicle wheel brakes, and wherein the central electronics controller is further programmed:
(a) to operate the electric traction motor as an electric braking generator for maintaining the speed of the vehicle substantially constant and charging the electric battery when the vehicle is moving forward at a speed lower than said first predetermined speed, said accelerator pedal is not depressed, and an acceleration of the vehicle is detected;
(b) to disengage the clutch, to operate said internal-combustion engine at said substantially constant speed within its optimum fuel-efficiency speed range, and to operate the traction motor as an electric braking generator for maintaining the speed of the vehicle substantially constant and charging the electric battery when the vehicle is moving forward at a speed higher than the first predetermined speed, the accelerator pedal is not depressed, and an acceleration of the vehicle is detected;
(c) When the vehicle is moving forward with a speed lower than the first predetermined speed and said brake pedal is depressed:
(i) to operate the electric traction motor as an electric braking generator when in response to the depression of the brake pedal the electric traction motor alone while charging the electric battery provides a continuously variable braking force capable of sustaining the vehicle speed during speed retardation or of decelerating the vehicle to a lower desirable speed during braking;
(ii) to operate the electric traction motor as an electric braking generator and, when in response to the depression of the brake pedal the electric traction motor alone does not provide a continuously variable braking force capable of sustaining the vehicle speed during speed retardation or of decelerating the vehicle to a lower desirable speed during braking, to gradually apply said wheel brakes, and then to control the continuously variable braking force of the wheel brakes in response to the depression of the brake pedal;
(iii) to discontinue the operation of the electric traction motor as an electric braking generator regardless of the depression of the brake pedal and to brake the vehicle only via the wheel brakes in response to the depression of the brake pedal when a pending lockup of any of said driving wheels is detected; and
(iv) to brake the vehicle only via the wheel brakes in response to the depression of the brake pedal when the electric battery is fully charged;
(d) When the vehicle is moving forward with a speed higher than the first predetermined speed and the brake pedal is depressed to disengage the clutch, to operate the internal-combustion engine at the predetermined substantially constant speed within its optimum fuel efficiency speed range, and:
(i) to operate the electric traction motor as an electric braking generator when in response to the depression of the brake pedal the electric traction motor alone while charging the electric battery provides a braking force capable of sustaining the vehicle speed during speed retardation or of decelerating the vehicle to a lower desirable speed during braking;
(ii) to operate the electric traction motor as an electric braking generator and, when in response to the depression of the brake pedal the electric traction motor alone does not provide a continuously variable braking force capable of sustaining the vehicle speed during speed retardation or of decelerating the vehicle to a lower desirable speed during braking, to gradually apply the wheel brakes, and then to control the continuously variable braking force of the wheel brakes in response to the depression of the brake pedal;
(iii) to discontinue the operation of the electric traction motor as an electric braking generator regardless of the depression of the brake pedal and to brake the vehicle only via the wheel brakes in response to the depression of the brake pedal when a pending lockup of any of the driving wheels is detected; and
(iv) to brake the vehicle only via the wheel brakes when the electric battery is fully charged; and
(e) when the vehicle is not moving or is moving backward to apply the wheel brakes in response to the depression of the brake pedal.
